(19) United States
(12) Patent Application Publication
(10) Pub. No.: US 2025/0026657 A1
(43) Pub. Date: Jan. 23, 2025

(54) EXTRACTION OF ALKALI FROM SILICATES

(71) Applicant: TERRA CO2 TECHNOLOGY HOLDINGS, INC., Golden, CO (US)

(72) Inventors: Donald John Lake, Vancouver (CA); Eliar Mosaferi, Vancouver (CA); Joshua Davies, Vancouver (CA)

(21) Appl. No.: 18/778,503

(22) Filed: Jul. 19, 2024

Related U.S. Application Data
(60) Provisional application No. 63/514,370, filed on Jul. 19, 2023.
(60) Provisional application No. 63/573,752, filed on Apr. 3, 2024.

(51) Int. Cl. C01D 7/26

(52) U.S. Cl. CPC C01D 7/26

(57) ABSTRACT

Described is a method for extracting alkali from silicates under carbon neutral conditions. The method involves providing a reaction mixture containing an alkali-bearing aluminosilicate composition and an alkali base composition. The reaction mixture is treated with a combined activation and leaching process to form a concentrated alkali-silicate solution and an alkali aluminosilicate solid residue, where carbon dioxide is produced as a carbon dioxide reusable co-product from the activation. The alkali aluminosilicate solid residue is reacted with a first portion of the carbon dioxide reusable co-product to form an alkali leached aluminosilicate composition, thereby extracting alkali from the alkali-bearing aluminosilicate composition. Also described are methods of making inorganic polymer cement and concrete from the products and/or co-products produced by the method of extracting.

### CROSS-REFERENCES TO RELATED APPLICATIONS

This application claims priority benefit of U.S. Provisional patent application Ser. No. 63/573,752, filed Apr. 3, 2024, and U.S. Provisional patent application Ser. No. 63/514,370, filed Jul. 19, 2023, the disclosures of which are hereby incorporated by reference herein in their entirety.

### FIELD

The present disclosure generally relates to, inter alia, methods of extracting alkali from silicates and uses thereof, including, for example, preparation of inorganic polymer cement and inorganic polymer concrete.

### BACKGROUND

Inorganic polymer chemistry is a viable route to decarbonizing cement for concrete on a global scale. However, such cements require a modest quantity of alkaline elements such as Na and K instead of the relatively large amount of calcium needed for traditional Portland cement. It is possible but impractical to obtain the required sodium and potassium from existing sources: e.g., chlor-alkali process, Solvay process, Hou process, mined sodium carbonate, and others. Of these sources, only mined sodium carbonate can provide enough alkali to support a global demand for inorganic polymer concrete (typically used in the form of liquid alkali silicate hardeners). Potassium carbonate is not similarly available in such deposits and is generally synthesized via electrolysis of potassium salts, contributing to its greater cost.

Unfortunately, sodium carbonate releases fossil CO₂ upon heating or decomposition for alkali silicate production. This is problematic for zero CO₂ production and a net zero CO₂ source of alkali metals is required to completely decarbonize inorganic polymer concrete.

If inorganic polymer cement is to contend as a replacement for Portland cement, all raw material inputs must be compatible with the principles of sustainable chemistry, large-scale global production, and tight price tolerance. The significant bottleneck facing the future of inorganic polymer cement production is to produce abundant alkali hardening reagents without generating process CO₂. Inorganic polymer cements are, most typically, at least two-part systems. The solid component of aluminosilicate reagent is compatible with bulk global production; however, the production pathway and supply chain of alkali silicate hardener requires particularly detailed examination in terms of raw material availability, energy use, byproducts/residuals, and CO₂ footprint.

Today, the supply of alkali silicate is inadequate for any significant transition to inorganic polymer, inorganic polymer hybrid, or alkali-activated cements. More importantly, the alkali raw material inputs such as mined sodium carbonate are not adequate in quantity or distribution for a global transition because sodium carbonate deposits are not even available on all continents, let alone most regional markets.

The entire silicate production supply chain likely requires reinvention to meet the economic, logistical, and low greenhouse gas (GHG) emission needs for a sustainable, global inorganic polymer cement industry. Hardeners for inorganic polymer are almost exclusively derived from sodium carbonate or salts with chloride byproducts, while most of the silicate crust is rich in untapped alkalis.

A convenient aspect of Portland cement is that only water is needed to cure a concrete mix. Inorganic polymer cement is different in that it requires a second reagent, much like catalyzed polymerization of organic resins. While water is generally abundantly available around the globe, the same cannot be said of a technical reagent such as soluble alkali silicate. If inorganic polymer cement is to be feasible beyond niche uses, we must consider whether the modern alkali silicate (hardener) supply chain is suitable to leap from a relatively small-scale and high purity reagent to a ubiquitous bulk commodity. The requirements of a viable cement silicate industry are simple; the cost of silicate hardener must allow inorganic polymer concrete to be competitive with current alternatives, and it must be feasible, sustainable and desirable to grow the silicate industry in tandem with inorganic polymer cement production. If global cement production (˜4,000 Mt/a) transitioned to inorganic polymer cement, alkali silicate hardener production on the order of 100-1,000 Mt/a would be needed. Current global production is ˜25 Mt/a, therefore, growing the existing industry by orders of magnitude is a significant proposition.

SiO₂ (quartz) supply for alkali silicate production is not an issue. Quartz is the second most abundant mineral in the continental upper crust and available in many rock types, often in relatively pure occurrences on each continent.

Mined sodium carbonate is the most obvious choice for larger supply (23 billion tons reserves in United States; USGS 2022) due to ease of processing relatively pure trona. However, the GHG emissions from further sodium carbonate decomposition for cements would be highly undesirable and potentially costly if carbon dioxide emissions are taxed in the future (there may be ways to mitigate this at significant additional cost such as carbon capture, utilization, and storage (CCUS)). There is also the important matter of whether it is feasible or wise to deplete a finite, valuable, mined strategic resource that is not globally ubiquitous.

Seawater, brine or mined evaporite-derived NaCl is an abundant and obvious second choice source of alkali. The sodium in seawater (3.5% NaCl w/w, 28.7 kg/ton NaCl equivalent) is mostly supplied by continental weathering—a natural chemical leaching process spanning most of Earth's history. Seawater and mined NaCl are quite abundant globally, which is a good first step. Unfortunately, NaCl runs into a common problem among available alkali salts whereby the accompanying anion restricts further scaling. At current levels, chlorine production is not only useful, but often the primary product of brine electrolysis. Global chlorine capacity is presently ˜58 Mt/a. This is used largely for sanitation and production of polyvinyl chloride (PVC, ˜59 Mt/a). There is no hypothetical shortage of renewable energy on Earth to scale brine electrolysis, but finding a useful destination for orders of magnitude more chlorine gas seems to rule out brine electrolysis as a general solution for scaling alkali production. Clearly, alternative production routes are required if inorganic polymer cement is to succeed commercially.

The difficulty of the alkali silicate hardener supply problem is intensified by the desire to reduce CO₂ impact. This additional requirement is challenging from a sustainable chemistry perspective for several reasons:

Alkaline elements at Earth's surface are commonly associated with carbonate anions (or similarly problematic sulfate, chloride, and fluoride anions among others).

Calcium carbonate is globally abundant, cheap, and provides a ready source of exchangeable cations useful for leaching alkaline elements in-situ at high pH in aqueous solution of cement mixes (e.g., as in Roman marine concrete) or when calcined to oxide form. However, it would be desirable to avoid releasing the fossil CO₂ from calcium carbonate which is typically required to make use of its calcium cations in a chemical process.

Most easily envisioned chemical processes (reagent production or in-situ in cement) that circumvent the alkali supply problem effectively, are either at the expense of releasing large amounts of CO₂ from abundant calcium carbonate or use lower reactivity mixes that take a very long time to cure (e.g., other soluble alkali salts at various pore solution pH levels). A significant bottleneck facing the future of inorganic polymer cement production is to produce abundant alkali salt solution hardening reagents without generating CO₂.

The present disclosure is directed to overcoming these and other deficiencies in the art.

### SUMMARY

The present disclosure generally relates to, inter alia, methods of extracting alkali from silicates, preparing alkali-silicate compositions from the extracted alkali, preparing activated kaolinite compositions, preparing inorganic polymer cement from alkali-silicate and from activated kaolinite compositions, and preparing inorganic polymer concrete from the inorganic polymer cement. The present disclosure also relates to the products and co-products produced by the methods described herein. The present disclosure relates to the use of the alkali-silicate compositions prepared according to the methods disclosed herein as reagents for preparing cement, including, without limitation, inorganic polymer cement.

In one aspect, the present disclosure relates to a method for extracting potassium, sodium, or both potassium and sodium from silicates under carbon neutral conditions. This method involves: (a) providing a reaction mixture comprising a first reactant and a second reactant, wherein the first reactant comprises a potassium-bearing aluminosilicate composition, a sodium-bearing aluminosilicate composition, or a mixture thereof, and wherein the second reactant comprises a corresponding potassium base composition, sodium base composition, or a mixture thereof; (b) treating the reaction mixture with a combined activation and leaching process to form a concentrated potassium-silicate solution, sodium-silicate solution, or mixture thereof and a corresponding potassium aluminosilicate solid residue, sodium aluminosilicate solid residue, or mixture thereof, wherein carbon dioxide is produced as a carbon dioxide reusable co-product from the activation; and (c) reacting the potassium aluminosilicate solid residue, the sodium aluminosilicate solid residue, or the mixture thereof with a first portion of the carbon dioxide reusable co-product to form a potassium leached aluminosilicate composition, a sodium leached aluminosilicate composition, or a mixture thereof, thereby extracting potassium, sodium, or a mixture thereof from the corresponding potassium-bearing aluminosilicate composition, sodium-bearing aluminosilicate composition, or mixture thereof.

In another aspect, the present disclosure relates to a composition comprising a potassium, sodium, or potassium and sodium leached aluminosilicate composition produced according to the method for extracting potassium, sodium, or both potassium and sodium from silicates under carbon neutral conditions, as described herein.

In another aspect, the present disclosure relates to a composition comprising a potassium, sodium, or potassium and sodium composition produced according to the method for extracting potassium, sodium, or both potassium and sodium from silicates under carbon neutral conditions, as described herein.

In another aspect, the present disclosure relates to a composition comprising an alkali product produced according to the method for extracting potassium, sodium, or both potassium and sodium from silicates under carbon neutral conditions, as described herein, wherein the alkali product is selected from the group consisting of alkali carbonate, alkali silicate, and the like.

In another aspect, the present disclosure relates to a method for extracting alkali from silicates, with concurrent formation of an activated synthetic kaolinite composition under carbon neutral conditions. This method involves: (a) providing a reaction mixture comprising an alkali-bearing aluminosilicate composition and an alkali base composition; (b) treating the reaction mixture with a combined activation and leaching process to form a concentrated alkali-silicate solution and an alkali aluminosilicate solid residue, wherein carbon dioxide is produced as a carbon dioxide reusable co-product from the activation; (c) reacting the alkali aluminosilicate solid residue with a first portion of the carbon dioxide reusable co-product to form an alkali leached aluminosilicate composition, thereby extracting alkali from the alkali-bearing aluminosilicate composition; and (d) activating the alkali leached aluminosilicate composition to form an activated synthetic kaolinite composition.

In another aspect, the present disclosure relates to a composition comprising an activated synthetic kaolinite composition produced according to the method for extracting alkali from silicates, with concurrent formation of an activated synthetic kaolinite composition under carbon neutral conditions, as disclosed herein.

In another aspect, the present disclosure relates to a composition comprising an alkali carbonate liquid produced according to the method for extracting alkali from silicates, with concurrent formation of an activated synthetic kaolinite composition under carbon neutral conditions, as disclosed herein.

In another aspect, the present disclosure relates to a composition comprising solid product produced according to the method for extracting alkali from silicates, with concurrent formation of an activated synthetic kaolinite composition under carbon neutral conditions, as disclosed herein.

In another aspect, the present disclosure relates to a composition comprising an alkali-silicate liquid produced according to the method for extracting alkali from silicates, with concurrent formation of an activated synthetic kaolinite composition under carbon neutral conditions, as disclosed herein.

In another aspect, the present disclosure relates to a composition comprising an alkali-silicate solid product produced according to the method for extracting alkali from silicates, with concurrent formation of an activated synthetic kaolinite composition under carbon neutral conditions, as disclosed herein.

In another aspect, the present disclosure relates to a composition comprising an optionally activated synthetic aluminosilicate with composition of approximately 1:1 ratio of aluminum to silicon, produced according to the method for extracting alkali from silicates, with concurrent formation of an optionally activated synthetic aluminosilicate composition under carbon neutral conditions, as disclosed herein.

In another aspect, the present disclosure relates to a method of preparing inorganic polymer cement. This method involves providing an activated synthetic kaolinite composition produced according to the various methods of the present disclosure; and using the activated synthetic kaolinite composition as a reagent to form inorganic polymer cement.

In another aspect, the present disclosure relates to a composition comprising an inorganic polymer cement produced according to the method of preparing inorganic polymer cement, as described herein.

In another aspect, the present disclosure relates to a method of preparing inorganic polymer concrete. This method involves: providing an inorganic polymer cement according to the present disclosure; and combining the inorganic polymer cement with a solid aggregate composition and an optional filler composition, thereby forming an inorganic polymer concrete, wherein the inorganic polymer is present in an amount ranging from 1-44 weight percent (wt %), the solid aggregate composition is present in an amount ranging from 55-95 wt %, and the optional filler composition is present in an amount ranging from 1-20 wt % of the inorganic polymer concrete.

In another aspect, the present disclosure relates to a composition comprising an inorganic polymer concrete produced according to the method of preparing inorganic polymer concrete, as described herein.

In one aspect, the present disclosure relates to a method for extracting alkali from alkali-bearing silicates under carbon neutral conditions. This method involves: (a) providing a reaction mixture comprising an alkali-bearing aluminosilicate composition and an alkali base composition that comprises the alkali contained in the alkali-bearing aluminosilicate; (b) treating the reaction mixture with a combined activation and leaching process to form a concentrated alkali-silicate solution and an alkali aluminosilicate solid residue, wherein carbon dioxide is produced as a carbon dioxide reusable co-product from the activation; and (c) reacting the alkali aluminosilicate solid residue with a first portion of the carbon dioxide reusable co-product to form an alkali leached aluminosilicate composition, thereby extracting alkali from the alkali-bearing aluminosilicate composition.

In another aspect, the present disclosure relates to a composition comprising an alkali leached aluminosilicate composition produced according to the method for extracting alkali from alkali-bearing silicates under carbon neutral conditions, as described herein.

As described herein, in certain aspects, the methods and compositions of the present disclosure involve the use of an alkali base composition that matches that of the feedstock (e.g., beta spodumene in this example) so that a portion of the resulting alkali carbonate product can be recycled into the first step, thus eliminating the need for fresh input of alkali carbonate into the process. Thus, in various aspects, the method of the present disclosure is advantageous over the state of the art at least in that it produces little to no waste or process carbon dioxide emissions and the alkali aluminosilicate co-product may further be used in other aspects of the processes and products of the present disclosure.

Unlike current processes, such as those that only aim to replace lithium in spodumene with a less expensive alkali, the processes of the present disclosure are effective to recover lithium using lithium carbonate. This process has the distinct advantage of significant waste reduction as a portion of the recovered lithium carbonate can be reused to leach more material from the spodumene feedstock.

As shown in Table 1 below, the methods of the present disclosure are superior to current methods in the field.

TABLE 1
Comparison of Methods of the Present Disclosure
(“TerraCO2 Process”) to Established
Industrial Carbonate Production Methods

| | Solution | Trona | Hou | Solvay | TerraCO2 |
|---|---|---|---|---|---|
| Process | Mining | Mining | Process | Process | Process |
| Type | Natural | Natural | Synthetic | Synthetic | Synthetic |
| Sodium | 4 | 13 | 12 | 31 | Not |
| Carbonate | | | | | resource |
| Production | | | | | limited |
| (Mt/a)* | | | | | |
| CO₂ Emissions | 0.45 | 0.75 | 1.05 | 1.10 | −0.83** |
| Factor | | | | | |
| (t CO₂/t Na₂CO₃) | | | | | |

*Uniquely, with the process of the present disclosure (TerraCO2 process), both potassium carbonate and sodium carbonate, and mixtures thereof, can be produced.
**A negative CO₂ emissions factor is possible using the process of the present disclosure (TerraCO2 process) with clean/renewable energy.

Additional aspects, advantages and features of the present disclosure will become more apparent upon reading of the following non-restrictive description of preferred embodiments which are exemplary and should not be interpreted as limiting the scope of the present disclosure.

### BRIEF DESCRIPTION OF THE DRAWINGS

A better understanding of the features, advantages and principles of the present disclosure will be obtained by reference to the following detailed description that sets forth illustrative embodiments, and the accompanying drawings, of which:

FIG. 1A illustrates an example of a sodium feldspar-based binder system as an open loop, complete utilization green process scheme according to an embodiment;

FIG. 1B illustrates an example of a sodium feldspar-based binder system as a closed loop completely circular green process scheme according to an embodiment;

FIG. 1C illustrates an example of a potassium feldspar-based binder system as an open loop, complete utilization green process scheme according to an embodiment;

FIG. 1D illustrates an example of a potassium feldspar-based binder system as a closed loop completely circular green process scheme according to an embodiment;

FIG. 2 is a flowchart illustrating production of Na₂CO₃ and synthetic metakaolin from alkali feldspar according to an embodiment;

FIG. 3 is a flowchart illustrating production of Alkali-Silicate with alkali derived from feldspar according to an embodiment;

FIG. 4 is a flowchart illustrating production of alkali feldspar derived inorganic polymer according to an embodiment;

FIG. 5 illustrates residues remaining after K-feldspar roast at 900° C. and water leached with: A) 1.2 eq. Na₂CO₃; B) 2.2 eq. Na₂CO₃; and C) 3.0 eq. Na₂CO₃ according to an embodiment;

FIG. 6 illustrates scanning electron microscopy data with energy dispersive X-ray spectroscopy (SEM-EDX) of residues remaining after K-feldspar roast at 900° C. with 3.0 eq. Na₂CO₃ and water leached according to an embodiment;

FIG. 7 illustrates the extent of alkali leaching after CO₂ sparging at elevated temperature according to an embodiment;

FIG. 8 illustrates the extent of alkali leaching after CO₂ sparging with optimized flow rates and temperatures according to an embodiment;

FIG. 9 illustrates SEM-EDX data of residue (synthetic kaolinite) from trickle-bed reactor CO₂ leach of hydroxycancrinite according to an embodiment;

FIG. 10 illustrates SEM-EDX data of the residue (synthetic kaolinite) after carbonation of hydroxycancrinite in the stirred reactor using 5 L/min CO₂ flow at elevated temperatures according to an embodiment;

FIG. 11 illustrates a comparison of XRD data of hydroxycancrinite starting material (blue), the alkali-leached residue after CO₂ carbonation in the stirred reactor (green), and the calcined alkali-leached residue (pink) according to an embodiment;

FIG. 12 illustrates a comparison of XRD data of hydroxycancrinite starting material (green), the alkali-leached residue after CO₂ carbonation in the trickle-bed reactor (blue), and the calcined synthetic kaolinite material (purple), according to an embodiment;

FIG. 13 illustrates a comparison of XRD data from a commercial metakaolin (red), synthetic metakaolin produced by CO₂ leaching of hydroxycancrinite in the trickle-bed reactor (blue), and synthetic metakaolin produced by CO₂ leaching in the stirred reactor (pink), according to an embodiment;

FIG. 14 illustrates scanning electron microscopy data with energy dispersive X-ray spectroscopy (SEM-EDX) of residues remaining after Na-feldspar (albite) roast at 950° C. with 3.0 eq. Na₂CO₃ followed by water leach according to an embodiment;

FIG. 15 illustrates scanning electron microscopy data with energy dispersive X-ray spectroscopy (SEM-EDX) of residue (synthetic kaolinite) remaining after high-pressure CO₂ leach of hydroxycancrinite (from albite) using a 2 L reactor according to an embodiment;

FIG. 16 illustrates an XRD spectra Na-feldspar (albite) (blue), and of water leached residues (hydroxycancrinite) following Na-feldspar roast with 3.0 eq. Na₂CO₃ (orange), and of CO₂ leached residues (synthetic kaolinite) following roast and water leach steps (pink) according to an embodiment;

FIG. 17 illustrates a comparison of X-ray diffraction (XRD) data from residues remaining after roast and leach of alpha-spodumene with 3 eq. Li₂CO₃ according to an embodiment;

FIG. 18 illustrates an XRD spectra of residues remaining after hydrothermal reaction between NaOH and K-feldspar (Bottom) versus residue formed during K-feldspar roast with 3.0 eq. Na₂CO₃ (Top—Example 1) according to an embodiment;

FIG. 19 illustrates a scanning electron microscopy (SEM) image of the residue (hydroxycancrinite) formed by the hydrothermal reaction between NaOH and K-feldspar according to an embodiment;

FIG. 20 illustrates an XRD of residue (kalsilite) remaining after hydrothermal reaction between KOH and K-feldspar (pink), and the residue (synthetic kaolinite) formed from CO₂ leaching of kalsilite (blue), according to an embodiment;

FIG. 21 illustrates SEM-EDX data for residue (kalsilite) formed by the hydrothermal reaction between KOH and K-feldspar according to an embodiment;

FIG. 22 illustrates SEM-EDX data for residue (synthetic kaolinite) from trickle bed reactor CO₂ leached kalsilite, according to an embodiment;

FIG. 23 illustrates an XRD of residues (synthetic kaolinite) remaining after leaching of hydroxycancrinite with various nitric acid concentrations (From top to bottom: 1.1 M, 0.8 M, and 0.5 M nitric acid) according to an embodiment;

FIG. 24 illustrates SEM-EDX data for residue (synthetic kaolinite) formed by leaching of hydroxycancrinite with 0.8 M nitric acid according to an embodiment;

FIG. 25 illustrates an XRD of calcined kaolinite (synthetic metakaolin) according to an embodiment;

FIG. 26 illustrates an XRD of residue (synthetic kaolinite) remaining after leaching of hydroxycancrinite with 1 M nitric acid according to an embodiment;

FIG. 27 illustrates SEM-EDX data for residue (synthetic kaolinite) formed by leaching of hydroxycancrinite with 1 M nitric acid according to an embodiment;

FIG. 28 illustrates an XRD of residue (synthetic kaolinite) remaining after leaching of kalsilite with 0.8 M nitric acid according to an embodiment;

FIG. 29 illustrates SEM-EDX data for residue (synthetic kaolinite) formed by leaching of kalsilite with 0.8 M nitric acid according to an embodiment;

FIG. 30 illustrates cumulative heat evolved at 40° C. for the following metakaolin samples mixed with K-silicate (Kasil—1.7 MR) to form an inorganic binder: Commercial metakaolin (blue), synthetic metakaolin produced by the CO₂ leaching in the trickle-bed reactor (purple), and synthetic metakaolin produced by the CO₂ leaching in the stirred reactor (red), according to an embodiment;

FIG. 31 illustrates cumulative heat evolved at 40° C. for synthetic metakaolin and synthetic kaolinite samples mixed with K-silicate (Kasil—1.7 MR) to form an inorganic binder, according to an embodiment;

FIG. 32 illustrates ²⁷Aluminum Magic Spin Angle Solid State Nuclear Magnetic Resonance Spectroscopy (NMR) showing similarities in Aluminum coordination of synthetic metakaolin produced by the TerraCO2 process (left and middle) and commercial metakaolin (right);

FIG. 33 illustrates approximate mass flows of one embodiment of the process when using a typical granite as feedstock to produce a dry ton of inorganic polymer cement; and

FIG. 34 illustrates approximate mass flows for one embodiment of integrating inorganic polymer cement production with an existing granite aggregate mine.

Further details of the present disclosure and its advantages will be apparent from the detailed description included below.

### DETAILED DESCRIPTION

The following detailed description provides a better understanding of the features and advantages of the aspects described in the present disclosure in accordance with the embodiments disclosed herein. Although the detailed description includes many specific embodiments, these are provided by way of example only and should not be construed as limiting the scope of the aspects disclosed herein.

In the following description of the embodiments, references to the accompanying drawings are by way of illustration of an example by which embodiments of the aspects of the present disclosure may be practiced. It will be understood that other embodiments may be made without departing from the scope of the aspects of the present disclosure disclosed.

This application is intended to describe one or more embodiments of the present disclosure. It is to be understood that the use of absolute terms, such as “must,” “will,” and the like, as well as specific quantities, is to be construed as being applicable to one or more of such embodiments, but not necessarily to all such embodiments. As such, embodiments of the present disclosure may omit, or include a modification of, one or more features or functionalities described in the context of such absolute terms. In addition, the headings in this application are for reference purposes only and shall not in any way affect the meaning or interpretation of the present disclosure.

In one aspect, the present disclosure relates to a method for extracting potassium, sodium, or both potassium and sodium from silicates under carbon neutral conditions. This method involves: (a) providing a reaction mixture comprising a first reactant and a second reactant, wherein the first reactant comprises a potassium-bearing aluminosilicate composition, a sodium-bearing aluminosilicate composition, or a mixture thereof, and wherein the second reactant comprises a corresponding potassium base composition, sodium base composition, or a mixture thereof; (b) treating the reaction mixture with a combined activation and leaching process to form a concentrated potassium-silicate solution, sodium-silicate solution, or mixture thereof and a corresponding potassium aluminosilicate solid residue, sodium aluminosilicate solid residue, or mixture thereof, wherein carbon dioxide is produced as a carbon dioxide reusable co-product from the activation; and (c) reacting the potassium aluminosilicate solid residue, the sodium aluminosilicate solid residue, or the mixture thereof with a first portion of the carbon dioxide reusable co-product to form a potassium leached aluminosilicate composition, a sodium leached aluminosilicate composition, or a mixture thereof, thereby extracting potassium, sodium, or a mixture thereof from the corresponding potassium-bearing aluminosilicate composition, sodium-bearing aluminosilicate composition, or mixture thereof.

In some embodiments, the activation process is selected from the group consisting of thermal, hydrothermal, chemical, mechanochemical, irradiative (e.g., microwave irradiation), electromagnetic, electrochemical activation, and the like.

In some embodiments, the heating comprises heating at a temperature ranging from about 850° C.-1100° C., about 900° C.-1050° C., or about 950° C.-1000° C., with a residence time ranging from about 0.25-4 hours, about 0.5-1.5 hours, or about 0.75-1.25 hours. In certain embodiments, the heating can take place, for example, in a ceramic or high alloy stainless steel vessel. In certain embodiments, the heating can take place, for example, in a static or flow through process. An example of heating can include, without limitation, the process of roasting, as understood in the art.

In some embodiments, the activation process is a hydrothermal process, where the hydrothermal process comprises heating at a temperature ranging from about 150° C.-275° C., about 175° C.-250° C., or about 200° C.-225° C., with a residence time ranging from about 1-72 hours, about 8-24 hours, or about 12-18 hours. In certain embodiments, the hydrothermal process can take place, for example, in a sealed autoclave lined with polytetrafluoroethylene (PTFE) or similar conditions understood in the art.

In some embodiments, the potassium-bearing aluminosilicate composition and the sodium-bearing aluminosilicate composition comprise feldspars. In certain embodiments, the feldspar can include, without limitation, alkali feldspar, plagioclase feldspar, and the like. In certain embodiments, the feldspar can include, without limitation, orthoclase, sanidine, microcline, anorthoclase, albite, oligoclase, andesine, labradorite, bytownite, anorthite, and mixtures or solid solutions thereof.

In some embodiments, the potassium-bearing aluminosilicate composition and the sodium-bearing aluminosilicate composition comprise feldspathoid minerals selected from the group consisting of nepheline, kalsilite, sodalite, leucite, hailyne, cancrinite, and the like.

In some embodiments, the potassium-bearing aluminosilicate composition and the sodium-bearing aluminosilicate composition comprise zeolite supergroup minerals comprising zeolites selected from the group consisting of analcime, chabazite, clinoptilolite, erionite, mordenite, phillipsite, ferrierite, natrolite, faujasite, and the like.

In some embodiments, the potassium-bearing aluminosilicate composition and the sodium-bearing aluminosilicate composition comprise mica group and clay group minerals, wherein the mica and clay minerals are selected from the group consisting of muscovite, biotite, phlogopite, smectite, illite, vermiculite, saponite, lepidolite, hectorite, and the like.

In some embodiments, the potassium base composition comprises is selected from the group consisting of potassium (K), potassium hydroxide (KOH), potassium carbonate (K₂CO₃), potassium oxide (K₂O), and mixtures thereof.

In some embodiments, the sodium base composition comprises is selected from the group consisting of sodium (Na), sodium hydroxide (NaOH), sodium carbonate (Na₂CO₃), sodium oxide (Na₂O), and mixtures thereof.

In some embodiments, the mixture of the potassium base composition and the sodium base composition comprises a mixture of two or more of compositions selected from the group consisting of potassium (K), potassium hydroxide (KOH), potassium carbonate (K₂CO₃), potassium oxide (K₂O), sodium (Na), sodium hydroxide (NaOH), sodium carbonate (Na₂CO₃), sodium oxide (Na₂O), and mixtures thereof.

In some embodiments, the potassium aluminosilicate solid residue, sodium aluminosilicate solid residue, or mixture thereof produced from the treating step has a silicon/aluminum (Si:Al) ratio ranging from about 0.8-1.8.

In some embodiments, the reacting step is conducted at a temperature ranging from about 150° C.-500° C., about 175° C.-225° C., or about 185° C.-210° C., at a pressure ranging from about 0-1500 pounds per square inch gauge (psig), about 50-600 psig, or about 100-300 psig for a period of time sufficient to leach substantially all remaining alkali into an alkali metal solution having a formula of M₂CO₃, wherein M is a corresponding alkali metal.

In some embodiments, the carbon dioxide produced from the method is substantially reused.

In another aspect, the present disclosure provides a composition comprising a potassium, sodium, or potassium and sodium leached aluminosilicate composition produced according to the method for extracting potassium, sodium, or both potassium and sodium from silicates under carbon neutral conditions, as described herein.

In another aspect, the present disclosure provides a composition comprising a potassium, sodium, or potassium and sodium composition produced according to the method for extracting potassium, sodium, or both potassium and sodium from silicates under carbon neutral conditions, as described herein.

In another aspect, the present disclosure provides a composition comprising an alkali product produced according to the method for extracting potassium, sodium, or both potassium and sodium from silicates under carbon neutral conditions, as described herein, wherein the alkali product is selected from the group consisting of alkali carbonate, alkali silicate, and the like.

In another aspect, the present disclosure provides a method for extracting alkali from silicates, with concurrent formation of an activated synthetic kaolinite composition under carbon neutral conditions. This method involves: (a) providing a reaction mixture comprising an alkali-bearing aluminosilicate composition and an alkali base composition; (b) treating the reaction mixture with a combined activation and leaching process to form a concentrated alkali-silicate solution and an alkali aluminosilicate solid residue, wherein carbon dioxide is produced as a carbon dioxide reusable co-product from the activation; (c) reacting the alkali aluminosilicate solid residue with a first portion of the carbon dioxide reusable co-product to form an alkali leached aluminosilicate composition, thereby extracting alkali from the alkali-bearing aluminosilicate composition; and (d) activating the alkali leached aluminosilicate composition to form an activated synthetic kaolinite composition.

In some embodiments of this method, the activating comprises a process of increasing reactivity selected from the group consisting of thermal, hydrothermal, chemical, mechanochemical, irradiative (e.g., microwave irradiation), electromagnetic, electrochemical activation, mechanical energy processes, and the like.

In some embodiments of this method, the activated synthetic kaolinite composition comprises metakaolin, vitrified kaolinite, calcined kaolinite, flash calcined kaolinite, activated clay with an Si:Al ratio ranging from about 0.5-1.5, or combinations thereof. In certain embodiments, the activated clay can have an Si:Al ratio that approaches 1.0.

In some embodiments of this method, the carbon dioxide produced from the method is substantially reused.

In some embodiments of this method, the reacting step is conducted at a temperature ranging from about 150° C.-500° C., about 175° C.-225° C., or about 185° C.-210° C., at a pressure ranging from about 0-1500 pounds per square inch gauge (psig), about 50-600 psig, or about 100-300 psig for a period of time sufficient to leach substantially all remaining alkali into an alkali metal solution having a formula selected from the group consisting of M₂CO₃, MOH, and M₂O, wherein M is a corresponding alkali metal.

In some embodiments of this method, the method further involves: concentrating, crystalizing, isolating, and/or transforming the alkali metal solution to form an alkali metal solid having a formula selected from the group consisting of M₂CO₃, MOH, and M₂O, wherein M is a corresponding alkali metal. According to the present disclosure, in certain embodiments, one of ordinary skill in the art can use techniques and protocols of the relevant field, as further combined with the present disclosure, to perform the steps of concentrating, crystalizing, isolating, and/or transforming the alkali metal solution to form the alkali metal solid as described herein.

In some embodiments of this method, the method further involves: re-introducing at least a portion of the alkali metal solid into the treating step as the alkali base composition, thereby forming a continuous loop of alkali base composition production and consumption.

In some embodiments of this method, the method further involves: reacting the concentrated alkali-silicate solution with a second portion of the carbon dioxide reusable co-product to form a solid silica gel and an alkali-carbonate solution.

In some embodiments of this method, the solid silica gel comprises silica (SiO₂) at a concentration ranging from about 75-100 wt %. In certain embodiments, the solid silica gel comprises silica (SiO₂) at a concentration ranging from about 75-100 wt % where the remainder is alkali carbonate.

In some embodiments of this method, the solid silica gel is reused for reacting or combining with the alkali base composition to form alkali silicate or as activated silica source for inorganic polymer cement production, or wherein the solid silica gel is reused for reacting or combining with an alkali-silicate composition.

In some embodiments of this method, the alkali-carbonate solution comprises M₂CO₃, at concentration ranging from 1-40 wt/wt % M₂CO₃ in water, wherein M is a corresponding alkali metal.

In some embodiments of this method, the method further involves: isolating an alkali carbonate composition from the alkali-carbonate solution; and combining the solid silica gel and the isolated alkali carbonate composition to form an alkali-silicate liquid.

In some embodiments of this method, the alkali-silicate liquid comprises silica (SiO₂) at a concentration ranging from about 10-50 wt % and comprises a weight ratio of SiO₂:M₂O ranging from about 1.0-4.0.

In some embodiments of this method, the method further involves: treating the alkali-silicate liquid to form an isolated alkali-silicate solid product. In certain embodiments, the treating can be performed, without limitation, through evaporation and recrystallization. In certain embodiments, the treating can be performed, without limitation, through evaporation and recrystallization, where the alkali-silicate solid product can be dried and maintained in a form including, for example, a hydrated crystal, an anhydrous crystal, and the like.

In another aspect, the present disclosure provides a composition comprising an activated synthetic kaolinite composition produced according to the method for extracting alkali from silicates, with concurrent formation of an activated synthetic kaolinite composition under carbon neutral conditions, as disclosed herein.

In another aspect, the present disclosure provides a composition comprising an alkali carbonate liquid produced according to the method for extracting alkali from silicates, with concurrent formation of an activated synthetic kaolinite composition under carbon neutral conditions, as disclosed herein.

In another aspect, the present disclosure provides a composition comprising solid product produced according to the method for extracting alkali from silicates, with concurrent formation of an activated synthetic kaolinite composition under carbon neutral conditions, as disclosed herein.

In another aspect, the present disclosure provides a composition comprising an alkali-silicate liquid produced according to the method for extracting alkali from silicates, with concurrent formation of an activated synthetic kaolinite composition under carbon neutral conditions, as disclosed herein.

In another aspect, the present disclosure provides a composition comprising an alkali-silicate solid product produced according to the method for extracting alkali from silicates, with concurrent formation of an activated synthetic kaolinite composition under carbon neutral conditions, as disclosed herein.

In another aspect, the present disclosure provides a composition comprising an optionally activated synthetic aluminosilicate with composition of approximately 1:1 ratio of aluminum to silicon, produced according to the method for extracting alkali from silicates, with concurrent formation of an optionally activated synthetic aluminosilicate composition under carbon neutral conditions, as disclosed herein.

In another aspect, the present disclosure provides a method of preparing inorganic polymer cement. This method involves providing an activated synthetic kaolinite composition produced according to the various methods of the present disclosure; and using the activated synthetic kaolinite composition as a reagent to form inorganic polymer cement.

In another aspect, the present disclosure provides a composition comprising an inorganic polymer cement produced according to the method of preparing inorganic polymer cement, as described herein.

In another aspect, the present disclosure provides a method of preparing inorganic polymer concrete. This method involves: providing an inorganic polymer cement according to the present disclosure; and combining the inorganic polymer cement with a solid aggregate composition and an optional filler composition, thereby forming an inorganic polymer concrete, wherein the inorganic polymer is present in an amount ranging from 1-44 weight percent (wt %), the solid aggregate composition is present in an amount ranging from 55-95 wt %, and the optional filler composition is present in an amount ranging from 1-20 wt % of the inorganic polymer concrete.

In some embodiments, the optional filler composition is selected from the group consisting of a reactive filler, an inert filler, and combinations thereof.

In some embodiments, the solid aggregate composition is selected from the group consisting of coarse, intermediate, fine, lightweight, engineered, manufactured, angular, rounded, water-worn, recycled, stone, sand, natural rock, industrial byproducts, alkali aluminosilicate, feldspar, and the like.

In another aspect, the present disclosure provides a composition comprising an inorganic polymer concrete produced according to the method of preparing inorganic polymer concrete, as described herein.

In one aspect, the present disclosure provides a method for extracting alkali from alkali-bearing silicates under carbon neutral conditions. This method involves: (a) providing a reaction mixture comprising an alkali-bearing aluminosilicate composition and an alkali base composition that comprises the alkali contained in the alkali-bearing aluminosilicate; (b) treating the reaction mixture with a combined activation and leaching process to form a concentrated alkali-silicate solution and an alkali aluminosilicate solid residue, wherein carbon dioxide is produced as a carbon dioxide reusable co-product from the activation; and (c) reacting the alkali aluminosilicate solid residue with a first portion of the carbon dioxide reusable co-product to form an alkali leached aluminosilicate composition, thereby extracting alkali from the alkali-bearing aluminosilicate composition.

In some embodiments of this method, the activating comprises a process of increasing reactivity selected from the group consisting of thermal, hydrothermal, chemical, mechanochemical, irradiative (e.g., microwave irradiation), electromagnetic, electrochemical, mechanical energy processes, and the like.

In some embodiments of this method, the heating comprises heating at a temperature ranging from about 850° C.-1100° C., about 900° C.-1050° C., or about 950° C.-1000° C., with a residence time ranging from about 0.25-4 hours, about 0.5-1.5 hours, or about 0.75-1.25 hours.

In some embodiments of this method, the activation process is a hydrothermal process and wherein the hydrothermal process comprises heating at a temperature ranging from about 150° C.-275° C., about 175° C.-250° C., or about 200° C.-225° C., with a residence time ranging from about 1-72 hours, about 8-24 hours, or about 12-18 hours.

In some embodiments of this method, the alkali-bearing aluminosilicate composition comprises feldspar.

In some embodiments of this method, the feldspar is selected from the group consisting of alkali feldspar and plagioclase feldspar.

In some embodiments of this method, the feldspar is selected from the group consisting of orthoclase, sanidine, microcline, anorthoclase, albite, oligoclase, andesine, labradorite, bytownite, anorthite, and mixtures or solid solutions thereof.

In some embodiments of this method, the alkali-bearing aluminosilicate composition comprises feldspathoid minerals selected from the group consisting of nepheline, kalsilite, sodalite, leucite, haüyne, cancrinite, and the like.

In some embodiments of this method, the alkali-bearing aluminosilicate composition comprises zeolite supergroup minerals comprising zeolites selected from the group consisting of analcime, chabazite, clinoptilolite, erionite, mordenite, phillipsite, ferrierite, natrolite, faujasite, and the like.

In some embodiments of this method, the alkali-bearing aluminosilicate composition comprises mica group and clay group minerals, wherein the mica and clay minerals are selected from the group consisting of muscovite, biotite, phlogopite, smectite, illite, vermiculite, saponite, lepidolite, hectorite, and the like.

In some embodiments of this method, the alkali-bearing aluminosilicate composition comprises spodumene, petalite, hectorite, eucryptite, and/or jadarite.

In some embodiments of this method, the alkali base composition comprises an alkali metal selected from the group consisting of sodium (Na), potassium (K), lithium (Li), and mixtures thereof.

In some embodiments of this method, the alkali base composition is selected from the group consisting of sodium hydroxide (NaOH), potassium hydroxide (KOH), lithium hydroxide (LiOH), and mixtures thereof.

In some embodiments of this method, the alkali base composition is selected from the group consisting of sodium carbonate (Na₂CO₃), potassium carbonate (K₂CO₃), lithium carbonate (Li₂CO₃), and mixtures thereof.

In some embodiments of this method, the alkali base composition is selected from the group consisting of sodium oxide (Na₂O), potassium oxide (K₂O), lithium oxide (Li₂O), and mixtures thereof.

In some embodiments of this method, the alkali base composition is selected from the group consisting of sodium bicarbonate (NaHCO₃), potassium bicarbonate (KHCO₃), lithium bicarbonate (LiHCO₃), and mixtures thereof.

In some embodiments of this method, the alkali aluminosilicate solid residue produced from the treating step has a silicon/aluminum (Si:Al) ratio ranging from about 0.8-1.8.

In some embodiments of this method, the reacting step is conducted at a temperature ranging from about 150° C.-500° C., about 175° C.-225° C., or about 185° C.-210° C., at a pressure ranging from 0-1500 pounds per square inch gauge (psig), about 50-600 psig, or about 100-300 psig for a period of time sufficient to leach substantially all remaining alkali into an alkali metal solution having a formula selected from the group consisting of M₂CO₃, MOH, and M₂O, wherein M is a corresponding alkali metal.

In some embodiments of this method, the carbon dioxide produced from the method is substantially reused.

In some embodiments, the alkali-bearing aluminosilicate composition comprises feldspar.

In some embodiments, the feldspar is selected from the group consisting of alkali feldspar ((K,Na)AlSi₃O₈) and plagioclase (NaAlSi₃O₈—CaAl₂Si₂O₈). Examples of such feldspars include, without limitation, orthoclase (KAlSi₃O₈), sanidine ((K,Na)AlSi₃O₈), microcline (KAlSi₃O₈), anorthoclase ((Na,K)AlSi₃O₈), albite ((Ab₉₀-Ab₁₀₀) NaAlSi₃O₈), oligoclase (Ab₇₀-Ab₉₀), andesine (Ab₅₀-Ab₇₀), labradorite (Ab₃₀-Ab₅₀), bytownite (Ab₁₀-Ab₃₀), anorthite ((Ab₀-Ab₁₀) CaAl₂Si₂O₈), and mixtures or solid solutions thereof. Examples of feldspars can include, without limitation, those feldspars characterized by the ternary classification diagram of feldspars, as known in the art.

In some embodiments, the alkali-bearing aluminosilicate composition comprises feldspathoid minerals. Examples of feldspathoids can include, without limitation, nepheline, kalsilite, sodalite, leucite, haüyne, and cancrinite.

In some embodiments, the alkali-bearing aluminosilicate composition comprises amorphous alkali materials such as soda-lime glass, aluminosilicate glass, volcanic glass, glass fibers, and metallurgical slags.

In some embodiments, the alkali-bearing aluminosilicate composition comprises zeolite supergroup minerals. Examples of zeolites can include, without limitation, analcime, chabazite, clinoptilolite, erionite, mordenite, phillipsite, ferrierite, natrolite, and faujasite,

In some embodiments, the alkali-bearing aluminosilicate composition comprises mica group and clay group minerals. Examples of mica and clay minerals, without limitation, include muscovite, biotite, phlogopite, smectite, illite, vermiculite, saponite, lepidolite and hectorite,

In some embodiments, the alkali-bearing aluminosilicate composition comprises, without limitation, spodumene, petalite, hectorite, eucryptite, and/or jadarite.

In some embodiments, the alkali base composition comprises an alkali metal selected from the group consisting of sodium (Na), potassium (K), lithium (Li), and mixtures thereof.

In some embodiments, the alkali base composition is selected from the group consisting of sodium hydroxide (NaOH), potassium hydroxide (KOH), lithium hydroxide (LiOH), and mixtures thereof.

In some embodiments, the alkali base composition is selected from the group consisting of sodium carbonate (Na₂CO₃), potassium carbonate (K₂CO₃), lithium carbonate (Li₂CO₃), and mixtures thereof.

In some embodiments, the alkali base composition is selected from the group consisting of sodium bicarbonate (NaHCO₃), potassium bicarbonate (KHCO₃), lithium bicarbonate (LiHCO₃), and mixtures thereof.

In some embodiments, the alkali base composition is selected from the group consisting of sodium oxide (Na₂O), potassium oxide (K₂O), lithium oxide (Li₂O), and mixtures thereof.

In some embodiments, the alkali base composition includes sodium, potassium, or a combination of sodium and potassium. In certain embodiments, the alkali base composition ranges from 0-100% sodium, from 0-100% potassium, or any combination of sodium and potassium content.

In some embodiments, the alkali aluminosilicate solid residue produced from the treating step has a silicon/aluminum (Si:Al) ratio ranging from about 0.8-1.8. In certain embodiments, the alkali aluminosilicate solid residue produced from the treating step can have a silicon/aluminum (Si:Al) ratio that approaches 1.0.

In some embodiments, the reacting step is conducted at a temperature ranging from about 150° C.-500° C., about 175° C.-225° C., or about 185° C.-210° C., at a pressure ranging from about 0-1500 pounds per square inch gauge (psig), about 50-600 psig, or about 100-300 psig for a period of time sufficient to leach substantially all remaining alkali into an alkali metal solution having a formula of M₂CO₃, wherein M is a corresponding alkali metal.

In some embodiments, the carbon dioxide produced from the method is substantially reused.

In another aspect, the present disclosure provides a composition comprising an alkali leached aluminosilicate composition produced according to the method for extracting alkali from silicates under carbon neutral conditions, as described herein.

In another aspect, the present disclosure provides a composition comprising an alkali leached aluminosilicate composition produced according to the method for extracting alkali from alkali-bearing silicates under carbon neutral conditions, as described herein.

One or more embodiments include a process for deriving alkali salts from alkali-bearing aluminosilicate materials and making beneficial use of co-products. In the best-known embodiment, feldspar minerals are the source of alkali, though only the chemistry of the material is important, and a wide range of alkali-bearing silicate materials may be suitable.

One or more embodiments include a process for deriving alkali salts from alkali-bearing aluminosilicate materials containing a mix of various alkali elements, including, but not limited to sodium, potassium, and lithium.

An embodiment of the present disclosure includes a process by which alkali is obtained from the alkali-bearing feedstock using mild conditions. Such a process may provide the almost complete yield of useful products from the feedstock. There is no significant waste because one unit of feed material may be converted to approximately one unit of useful cementitious reagents and optionally aggregate, all of which serve to produce concrete almost wholly from a feldspathic rock starting material, for example. Known processes for extracting elements from highly coordinated silicate minerals employ the use of strong acids to break down crystal structure with no regard given to recycling or regeneration of the acid reagent. Nor is it common that valuable uses are found for byproducts or tailings of conventional processes. The processes of the present disclosure can be carried out with relatively mild reagents that can be recycled/regenerated for further use, while the co-products are useful and intentional additions to low-CO₂ cement and concrete. Although extracting alkali from silicate minerals has been of industrial interest for at least a century, very few economic processes have been realized that achieve this due to the inherent difficulty of breaking down silicates (i.e., harsh reagents were previously required). The present process employs readily available starting materials, mild reagents and processing conditions that avoid disposal of harmful reagents and chemicals, and the raw material inputs are globally abundant and widespread.

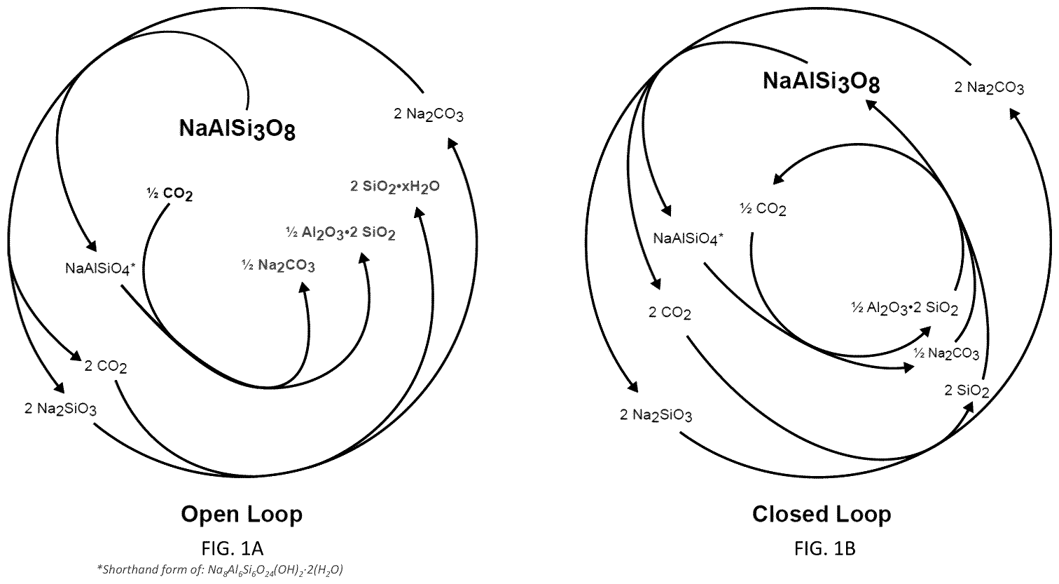

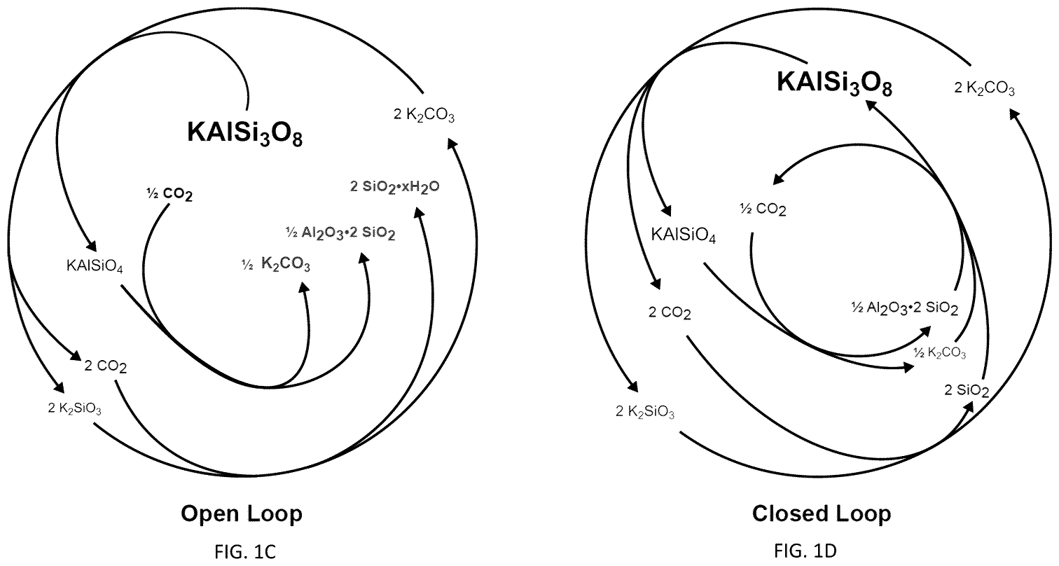

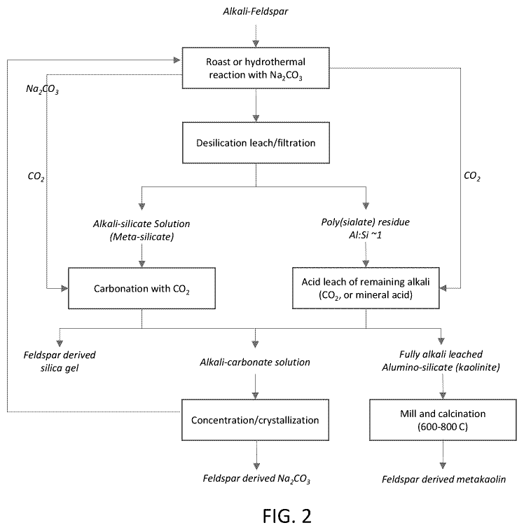

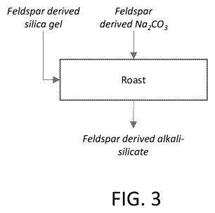

The processes of extracting alkalis from alkali-bearing aluminosilicates are illustrated as open loop systems in FIG. 1A and FIG. 1C, and as closed loop systems in FIG. 1B and FIG. 1D. By way of example, an embodiment of a process of extracting alkalis from alkali-bearing aluminosilicates according to the present disclosure is summarized in the circular closed loop scheme of FIG. 1B for the sodium feldspar-based closed loop system, and the process flow chart of FIG. 2 where feldspar is used as an example. Overall, this scheme is consistent with practices of green, closed loop chemistry. Most importantly, CO₂ formed during roasting is recovered and used for subsequent carbonation steps. Co-products like silica-gel are very convenient to use in alkali-silicate binder production steps whereby the consumption of energy is expected to be much lower when substituting silica gel for quartz in a traditional roast of quartz and Na₂CO₃. Finally, any mineral co-products, such as non-feldspar gangue produced during the concentration of alkali-rich feldspar from a feldspar ore (e.g., a granitic rock), may be used as aggregate in concrete production. Such a co-product should be well characterized, controlled and contribute to a robust, vertically integrated supply chain of cementitious products and aggregate materials. This may be one approach to optimize production value from an aggregate mine.

In the first step, an alkali-bearing aluminosilicate, such as potassium-feldspar in the best-known example, is purified and/or enriched from other minerals using existing mining and metallurgical processes, such as flotation, classification, magnetic separation, and so forth. The material rejected from this process may be used as aggregate if suitable.

During the next step the alkali-bearing aluminosilicates (alkali feldspar) are roasted with an alkali base (Na, Li, or K hydroxide, carbonate, bicarbonate, and the like), in the best studied case, Na₂CO₃. The same outcome can also be obtained under hydrothermal conditions in strong alkali solutions containing alkali feldspar. After roasting with alkali carbonate, a concentrated alkali-silicate solution is obtained through hydrothermal leaching of the solid product with subsequent liquid-solid separation. With 2 out of 3 silicon atoms removed, this solid residue has an attractive Si:Al ratio (close to 1), for use in inorganic polymers; however, the aluminum remains associated with one equivalent of alkali (i.e., molar ratio of alkali elements to aluminum is approximately one) that can be further extracted to increase the alkali yield.

The solid alkali aluminosilicate (Si:Al˜1) is sparged with CO₂ at an elevated temperature and pressure until the remaining alkali contained is leached into solution as M₂CO₃ (where M denotes one or more alkali metals), which can be blended in with the stream of M₂CO₃ formed below and recovered. As shown in FIG. 2, the final solid residue, which is now kaolinite-like in composition (Al₂[Si₂O₅](OH)₄), is further activated through calcination to produce a synthetic metakaolin that is advantageous for use in concrete, particularly inorganic polymer concrete.

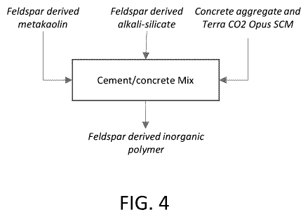

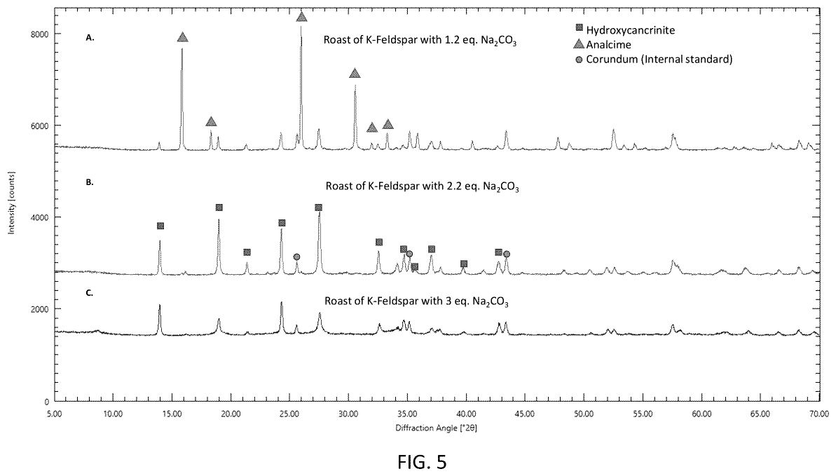

The alkali-silicate solution formed after the earlier roast and leach, is then completely leached of alkali by sparging with CO₂ to form solid silica gel and, in the case of a sodium system, Na₂CO₃/NaHCO₃, in solution. Following another solid-liquid separation, the solution of Na₂CO₃ is concentrated and the product is isolated by, for example, evaporative crystallization. Most of this Na₂CO₃ is re-introduced to the roasting step, thereby forming a continuous loop of Na₂CO₃ production and consumption. The silica gel collected can be reacted or combined with the remainder of Na₂CO₃ from the process (i.e. excess Na₂CO₃ contributed from feldspar) in a roast and hydrothermal reaction at 175° C.-225° C. to form alkali silicate, or it can be used in the final cement or concrete as an activated silica source as shown in FIG. 4. In certain other embodiments, the hydrothermal reaction can be performed at a temperature ranging from about 150° C.-500° C., about 175° C.-225° C., or about 185° C.-210° C.

Additionally, the alkali carbonates and alkali silicates produced from this process present a valuable source of feedstock for other commodity materials, such as glass. These alkali-silicates and alkali-carbonates may be identical to current commodity sources of alkali, and thus can be used as drop-in replacements. The manufacturing process for soda-lime glass consists of melting the raw materials (sodium carbonate, silica, lime, and other magnesium and aluminum minerals) in a glass furnace at temperatures around 1500° C.-1700° C. In order to reduce costs, pure chemicals are generally replaced with relatively inexpensive sources, such as trona and quartz sand. However, the processes described in this application provide both silica (SiO₂) and sodium carbonate (Na₂CO₃) as co-products. Furthermore, current soda-lime glass production is also heavily influenced by the availability of alkali from mining or synthetic processes. As well, both mined and synthetic soda ash produce large amounts of feedstock process CO₂ emissions whereas this process has the potential to make scalable, carbon-neutral glass.

The process herein may also employ atmospheric CO₂ and/or other sources of CO₂ as a process input to sequester CO₂ in the form of an alkali carbonate product if desirable. Given that alkali carbonates are used as commodity inputs in a wide variety of downstream products, this may be useful in applications where the CO₂ in sodium carbonate or potassium carbonate can act as a long-term carbon sink. In such a way, alkali carbonate produced using this method could provide a pathway to carbon-neutral or carbon-negative derivative products further down the supply chain.

For example, sodium carbonate or potassium carbonate produced from this process could be used to decarbonize certain methods of lithium carbonate or lithium hydroxide production such as the analcime method of lithium production from silicate ores which is an improvement over previous methods but remains responsible for one mole of CO₂ pollution per mole of lithium produced (due to use of Ca(OH)₂ typically derived from calcination of CaCO₃). If such a process were to employ a CO₂ negative sodium carbonate as feedstock (as could be produced using methods herein) it would be possible to make the analcime lithium process carbon neutral. In such a case, the synthetic analcime waste product from lithium production could be processed according to the present disclosure to provide a source of carbon neutral or carbon negative sodium carbonate, thus making the lithium extraction process potentially carbon neutral.

In certain aspects, the methods and compositions of the present disclosure are suitable for use in preparing and using green commodity alkali materials. In certain embodiments, the green commodity alkali materials can include, without limitation, glass, alkali-silicates, alkali-carbonates, alkali-hydroxides, alkali-oxides, and the like.

### EXAMPLES

The following examples are intended to illustrate particular embodiments of the present disclosure, but are by no means intended to limit the scope of the present disclosure.

### Example 1

### Na₂CO₃ Roast with K-feldspar and Subsequent CO₂ Leach of Hydroxycancrinite

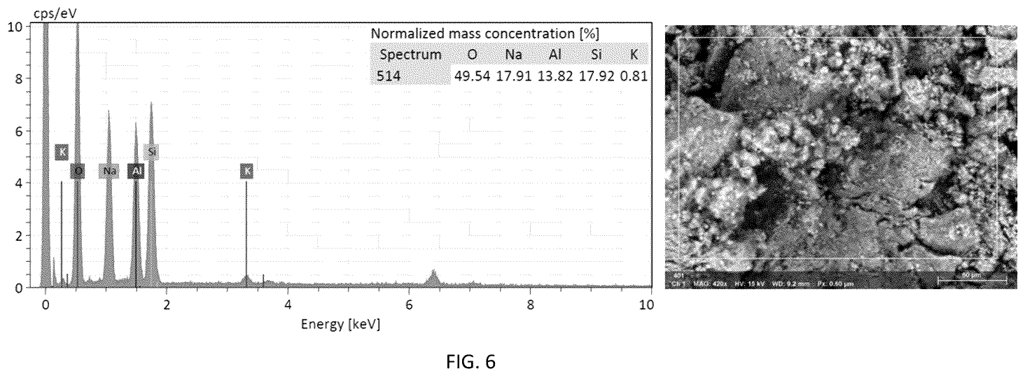

Commercially available potassium feldspar (Custer), milled to a D₅₀ of 8 um, was well blended with Na₂CO₃ (>99.5% pure, 3 molar equivalents), and heated to 900° C. on a Hastelloy tray for 2 hours in a furnace. The resulting melted product was coarsely milled and extracted in an autoclave with deionized (DI) water (liquid-to-solid ratio range of 1-5) at 240° C. for 6 hours. The residue was rinsed with two-fold this volume of DI water, and the solid was oven dried overnight at 105° C. before characterization with XRD (see FIG. 5), SEM-EDX (see FIG. 6), and X-ray Fluorescence (XRF) (see Table 2 below). The liquid extract (sodium silicate) was characterized as quantitative by ICP (see Table 3) and had a total dissolved solids value of 25.6%.

TABLE 2
XRF Composition Data for K-feldspar, Roast Residue and Leached Residue
XRF Composition (%)

| Sample | Al₂O₃ | K₂O | Na₂O | SiO₂ | LOI | SiO₂/Al₂O₃ |
|---|---|---|---|---|---|---|
| K-feldspar | 14.9 | 6.98 | 3.4 | 72.48 | 0.4 | 4.9 |
| Glass A (1.2 eq. Na₂CO₃) | 11.73 | 5.49 | 24.85 | 57.23 | 0.7 | 4.9 |
| Leached Glass A (1.2 eq. Na₂CO₃) | 23.44 | 1.57 | 16.03 | 52.06 | 6.9 | 2.2 |
| Glass B (2.2 eq. Na₂CO₃) | 9.84 | 4.61 | 34.68 | 48.27 | 2.6 | 4.9 |
| Leached Glass B (2.2 eq. Na₂CO₃) | 28.04 | 1.04 | 24.17 | 39.25 | 7.5 | 1.4 |

TABLE 3
Elemental Analysis Data for Alkali-silicate Solution

| Silicon Species by ICP | Amount |
|---|---|
| Silicon Concentration (g/L) | 31.6 |
| Silicate Concentration (g/L) | 137.3 |
| Theoretical Silicate Yield (g) | 49.2 |
| Actual Silicate Yield (g) | 50.1 |
| Silicate Yield (%) | 102% |

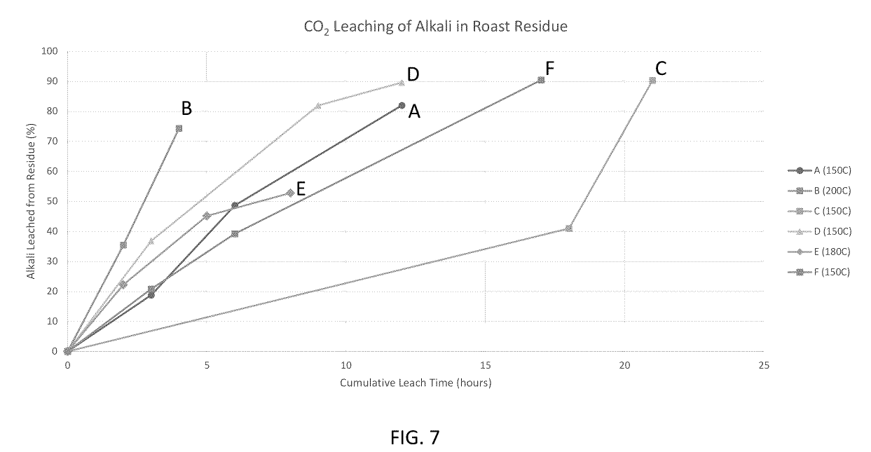

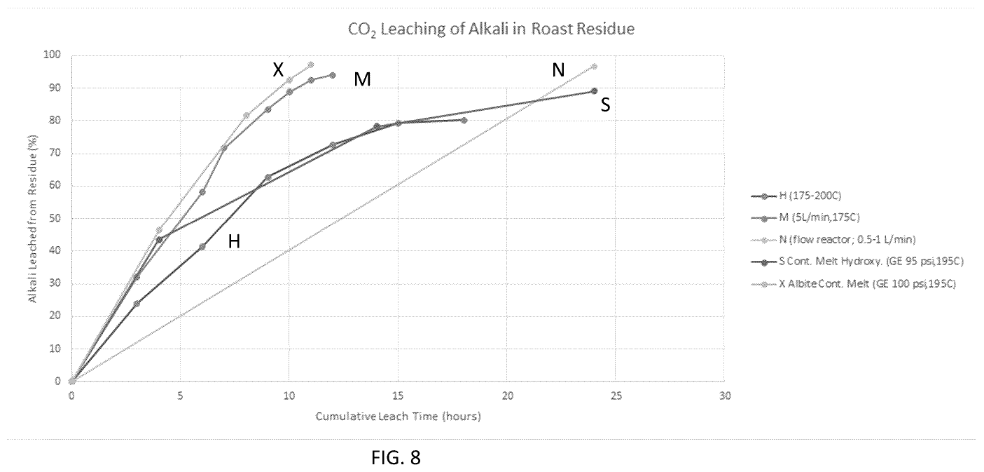

The above solid residue was wet-milled to an average particle size of 10-15 um before being taken up in DI water with a liquid to solid ratio (L/S) of 5 and placed in a stirred pressure reactor. With agitation (400-1100 rpm), the slurry was placed under 50-200 psig CO₂, and heated to 150-200° C. and continuously sparged with CO₂. Continuous introduction of water kept the L/S constant. After a predetermined time, the solids were filtered, washed, dried, and analyzed by SEM-EDX for alkali content. The leachate from this step will be combined and treated with the alkali-silicate leachate below. Variations in temperature, reaction time, and CO₂ pressure were considered in optimizing the reaction process (see FIG. 7 and FIG. 8).

In another example of alkali extraction by carbonation, the solid residue discussed above was packed into a continuous flow (trickle-bed) reactor (TBR), and extracted using a variety of parameters. Variations in temperature 150-225° C., reaction time (6-24 hours), water flow rate (0.5-5 ml/minute, and CO₂ pressure (100-1500 psig) were considered in optimizing the reaction process.

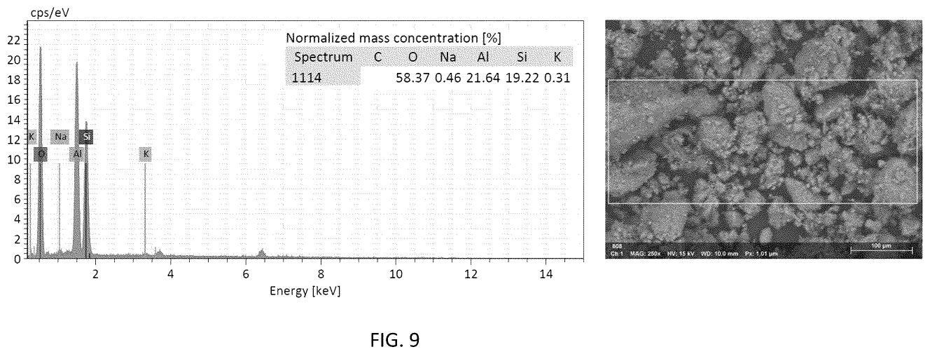

The primary goal of CO₂ carbonation is to remove alkali in the form of carbonate salts for further processing. Serendipitously, the remaining residue bears great resemblance to kaolinite minerals which can be further tuned to be used as additives in inorganic polymer cement. Mined kaolinite is typically almost devoid of alkali with a Si:Al ratio that is nearly unity. Therefore, the alkali:Al and Si:Al ratios in the leached residues are used as metrics for determining the efficiency of carbonation reactions. As seen in FIG. 7, 12-hour carbonation reaction with a stirred reactor at 150° C. results in 90% reduction in alkali content by SEM/EDX in the residue, while a 17-hour reaction at 150° C. yields 91% reduction in alkali content. No significant difference was observed between reactions at 150° C. and 200° C. The increased pressure input at 200° C. was necessary due to the design of the water replacement setup, not as a result of increased CO₂ demand. Preliminary evidence suggests that shorter reactions proceed at a faster rate initially than longer reactions. As seen in FIG. 8, the 24-hour trickle-bed reactor carbonation at 200° C., 400 psi CO₂, and flow rate of 3 ml/minute results in 97% reduction in alkali content determined by SEM/EDX in the residue (See FIG. 9).

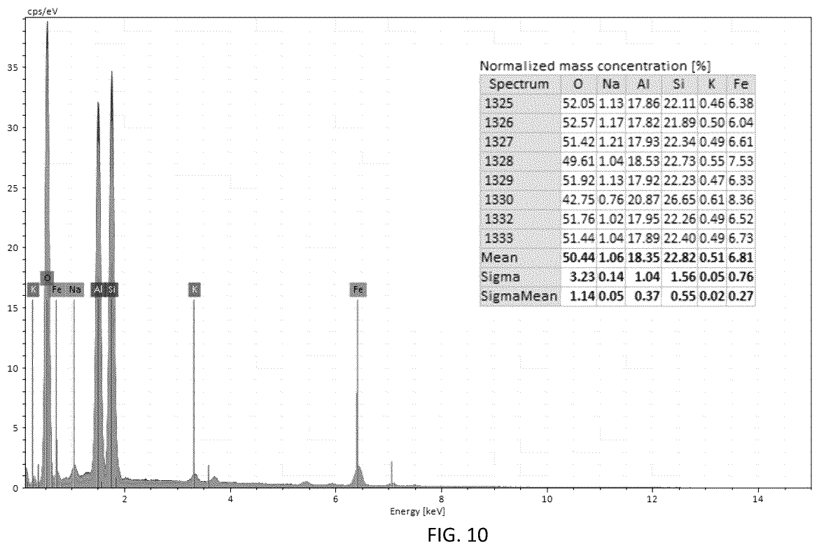

Increasing the flow of CO₂ through the stirred tank reactor results in greater leaching rate, as seen in FIG. 8. An increase to 5 L/min in gas flow at 175° C. results in 95% leaching of alkali from the residue in 12 hours. SEM-EDX data show an alkali:Al ratio of 0.08 (FIG. 10), which is confirmed by Inductively Coupled Plasma Optical Emission spectroscopy (ICP-OES) experiments on the bulk sample.

In another embodiment, the hydroxycancrinite residue was briefly ground by hand to a coarse powder and placed inside a 2 L stainless steel reactor equipped with gas inlet tube, overhead stirrer, and thermocouple. The residue was suspended in deionized water (0.5-1.5 L) and CO₂ was introduced into the reactor at pressures between 100 and 250 psi with vigorous stirring. The reactor was heated to 190° C. for a period ranging between 4 and 24 hours. After completion of the reaction, the reactor was cooled to room temperature and the suspension removed. A small aliquot of the sample was filtered over a Buchner funnel and washed with hot deionized water and dried at 100° C. before analysis by SEM/EDX. The bulk residue sample can then be decanted and used in further carbonation steps, if necessary, to increase alkali yield. No further processing of residue, such as milling or drying, is necessary. FIG. 8 provides examples of these reactions (plots S and X), showing the high degree of leaching after just three successive leach attempts.

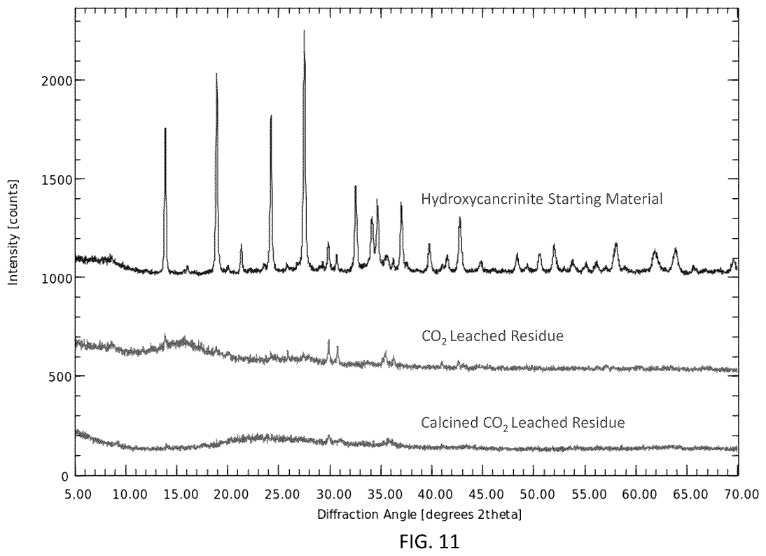

The resulting residues from the CO₂ leaching process were analyzed by SEM-EDX and XRD to verify the presence of synthetic kaolinite as the by-product of the alkali leaching reaction (see FIG. 10 and FIG. 11). The XRD plots show the disappearance of starting material peaks and the appearance of a very broad and amorphous peak at 23°, indicative of a kaolinite-like material. Additionally, no crystalline quartz or nepheline phases were identified in the residue.

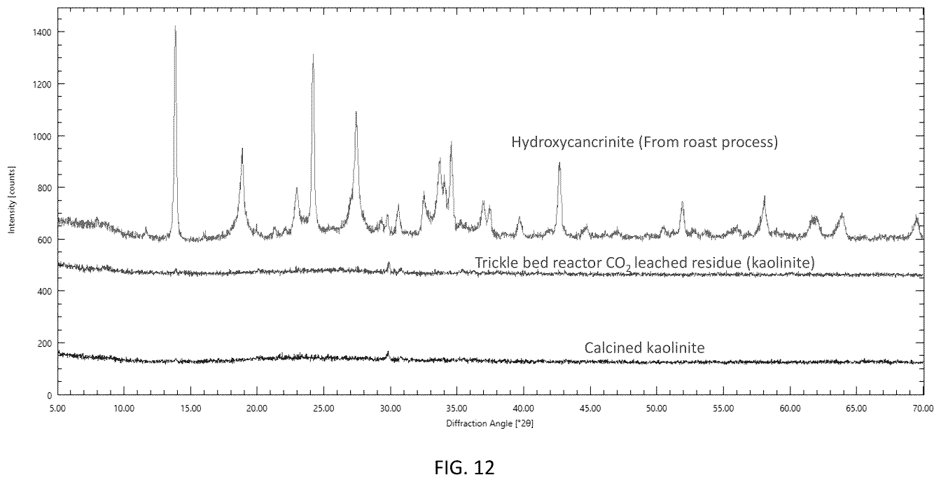

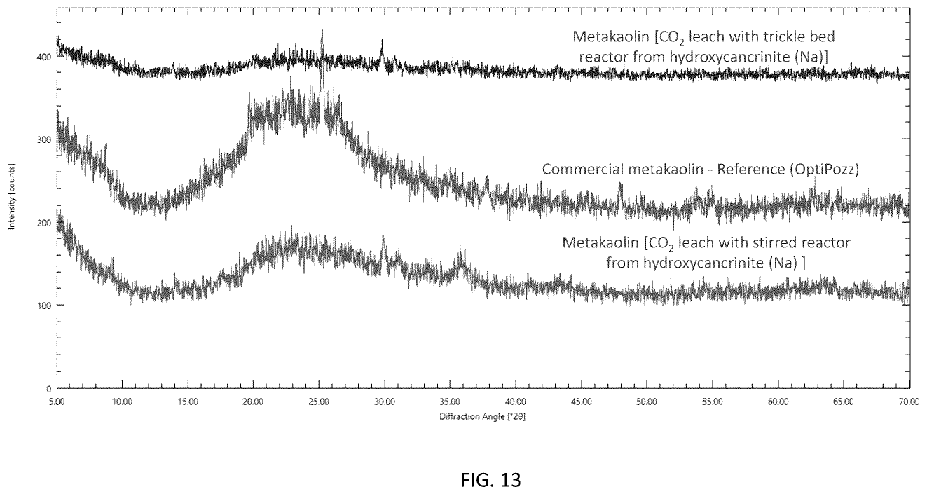

The fully leached solid residue (synthetic kaolinite) from either CO₂ leaching process was milled to an average particle size of 10 um before further activation by calcination at 775° C. in a furnace for 1.5 hours, with a 1.5 hour ramp-up and ramp-down time. Alternatively, kaolinite can be activated by ultra-fast vitrification with a residence time in the order of milliseconds and temperatures in the range of 1000° C. to 1700° C., These products were characterized by XRD (see FIG. 11 and FIG. 12) and used as a source of metakaolin for inorganic polymer applications without further processing. XRD shown in FIG. 13 is included to show both calcined, CO₂ leached residues have a similar amorphous phase to a high-quality commercial Metakaolin (OptiPozz).

The liquid sodium silicate formed in the first step was leached of alkali by bubbling a stirred solution with CO₂ until a pH drop from 13 to 9 was realized. The first crop of silica gel was filtered off, rinsed, and the carbonation process was repeated to obtain a 2nd crop at pH 8. The combined portions of silica gel were dried at 105° C. for 3 hours before ramping up to 500° C. when the gel-associated water was lost.

The filtrates (mixture of Na₂CO₃ and NaHCO₃) from the step above were combined and concentrated by thermal evaporation to near dryness as a thick slurry, and subsequently collected by vacuum filtration, followed by oven drying. Alternatively, if a very high purity product is desirable, the mixture of Na₂CO₃ and NaHCO₃ can be evaporated to a total solid content of 50% (or until the solution appeared slightly turbid). The warm solution was cooled to 5-10° C., and a mixture of Na₂CO₃ and NaHCO₃ was filtered off before repeating the evaporative recrystallization two more times. The product was analyzed by XRF for composition (see Table 4), and the overall yield was 95%. The loss on ignition value (LOI), which likely corresponds to CO₂, is very close to the expected value if Na₂CO₃ and NaHCO₃ were equal in concentration. The final liquid, which contains small amounts of Na₂CO₃/NaHCO₃ can be used as a rinsing stream consistent with practices of green, closed loop chemistry. Na₂CO₃/NaHCO₃ was recycled to the initial feldspar roasting step, with excess going into the industrially known alkali-silicate liquid production with silica-gel formed above.

TABLE 4
Elemental Analysis of Crystallized Carbonate/Bicarbonate by XRF.
XRF Composition (%)

| Sample | Al₂O₃ | K₂O | Na₂O | SiO₂ | LOI |
|---|---|---|---|---|---|
| Crystallized Na₂CO₃/NaHCO₃ | 0.05 | 1.18 | 47.7 | 0.86 | 50.1 |
| Theoretical composition if | — | — | 48.5 | — | 51.5 |
| Na₂CO₃═NaHCO₃ | | | | | |

Finally, inorganic polymer cement can be made by combining the alkali-silicate liquid (or derivatives) and synthetic metakaolin formed in the above steps. Furthermore, concrete can be formed by adding co-product or other aggregate to the cementitious reagents above.

### Example 2

### Na₂CO₃ Roast with Na-Feldspar (Albite) and Subsequent CO₂ Leach of Hydroxycancrinite

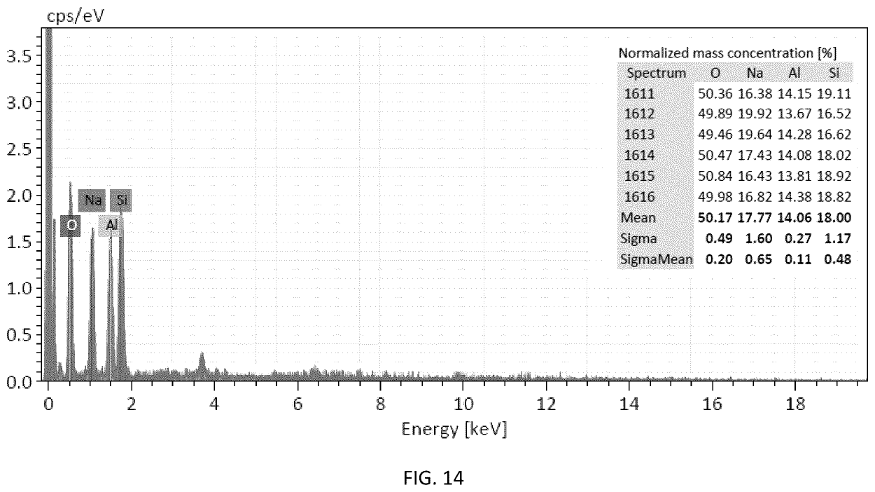

Albite mineral measuring 5 cm to 10 cm was crushed to <1 mm, blended with Na₂CO₃ (>99.5% pure, 3 molar equivalents), and heated to 950° C. on a Hastelloy tray for 1.5 hours in a furnace. The resulting melted product was coarsely milled and extracted in an autoclave with DI water (liquid-to-solid ratio range of 1-5) at 225° C. for 12 hours. The residue was rinsed with two-fold this volume of DI water, and the solid was oven dried overnight at 105° C. The resulting residue was characterized by SEM-EDX (FIG. 14).

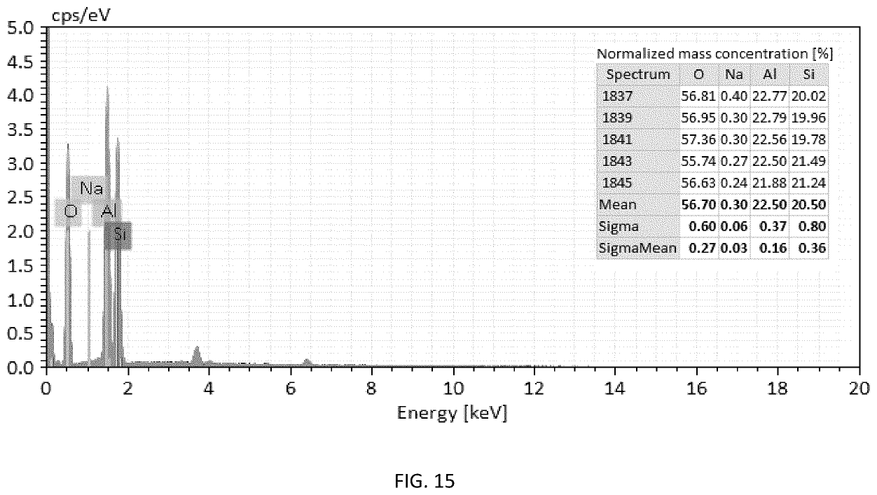

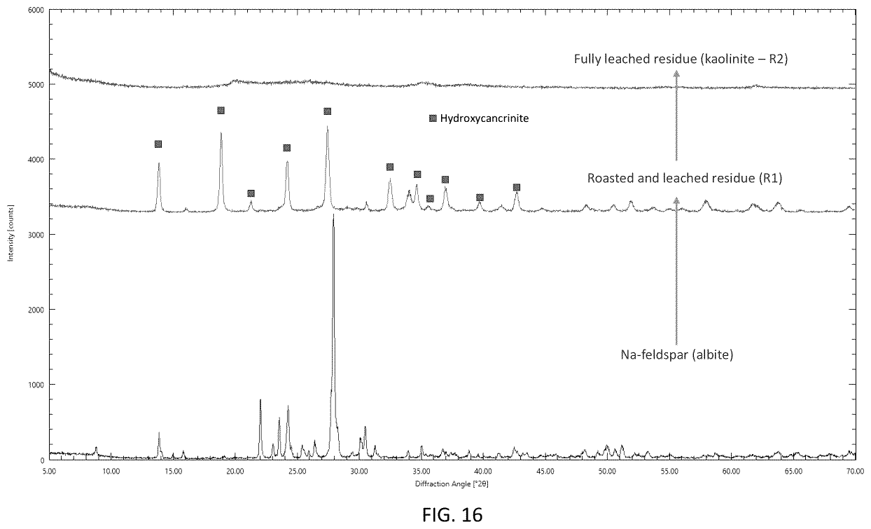

The above solid residue (˜10 g) was roughly crushed in mortar pestle before being taken up in DI water (750 mL) and placed in a stirred pressure reactor. With vigorous agitation (˜1000 rpm), the slurry was placed under ˜100 psig CO₂ and heated to 190° C. under static pressure of CO₂. After a predetermined time, the solids were filtered, washed with hot deionized water, dried, and analyzed by SEM-EDX (FIG. 15) for alkali content, and XRD (FIG. 16) to determine the mineral phases present. The leachate from this step will be combined and treated with the alkali-silicate leachate in examples below.

The resulting residues from the CO₂ leaching process were analyzed by SEM-EDX and XRD to verify the presence of kaolinite as the by-product of the alkali leaching reaction (see (FIG. 16). The XRD plots show the disappearance of starting material peaks and the appearance of a very broad and amorphous peak at 23°, indicative of a kaolinite-like material. Additionally, no crystalline quartz or nepheline phases were identified in the residue.

As with Example 1, the fully leached solid residue (synthetic kaolinite) from the CO₂ leaching process can be activated by calcination at 775° C. in a furnace for 1.5 hours, with a 1.5 hour ramp-up and ramp-down time. Alternatively, kaolinite can be activated by ultra-fast vitrification with a residence time in the order of milliseconds and temperatures in the range of 1000 to 1700° C. These products can be used as a source of metakaolin for inorganic polymer applications without further processing.

As with Example 1, the liquid sodium silicate formed in the first step can be leached of alkali in two stages with low pressure CO₂, allowing the collection of silica gel, which was washed and dried at 200° C. overnight.

The filtrates (mixture of Na₂CO₃ and NaHCO₃) from the step above can be concentrated by thermal evaporation to near dryness as a thick slurry, and collected by vacuum filtration, followed by oven drying.

Finally, inorganic polymer cement can be made by combining the alkali-silicate liquid (or derivatives) and synthetic metakaolin formed in the above steps. Furthermore, concrete can be formed by adding co-product or other aggregate to the cementitious reagents above.

### Example 3

### Li₂CO₃ Roast with Alpha-Spodumene and Subsequent CO₂ Leach

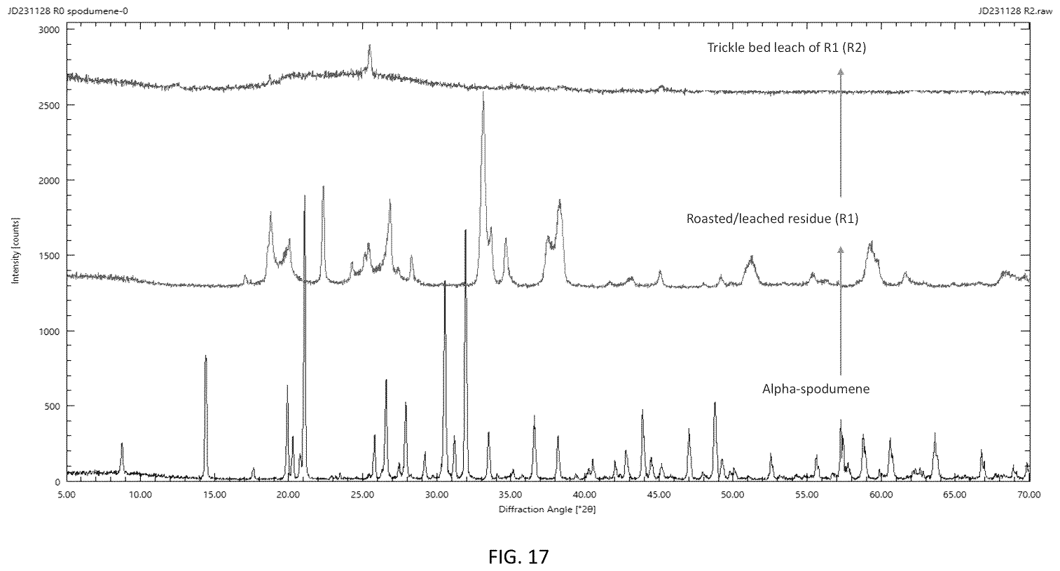

Fine, commercially available alpha-spodumene, was well blended with Li₂CO₃ (>99.5% pure, 3 molar equivalents), and heated to 900° C. on a Hastelloy tray for 2 hours in a furnace. The resulting melted product was coarsely milled and extracted in an autoclave with DI water (liquid-to-solid ratio range of 1-5) at 240° C. for 12 hours. The residue was rinsed with two-fold this volume of DI water, and the solid was oven dried overnight at 105° C. before characterization with XRD (see FIG. 17).

As performed in Example 1 [0115], the solid residue discussed above was packed into a continuous flow, trickle-bed, reactor (TBR), and extracted at a temperature of 225° C., reaction time (18 hours), water flow rate (3 ml/minute, and CO₂ pressure (600 psig). The residue along with the starting materials were analyzed by Peroxide Fusion ICP-ES and XRD (see Table 5 and FIG. 17). A 75% extraction of lithium from alpha-spodumene was achieved by the sequential roast and high pressure CO₂ process. One reason for the less than quantitative extraction of lithium is the reported low aqueous solubility of lithium silicate. Not only would this step limit the initial lithium removal, but incomplete desilication would further limit extraction of lithium as Li₂CO₃ during the TBR step. Another potential reason for the lower than normal alkali extraction is the low solubility for the Li₂CO₃ product that would potentially remain in the residue.

TABLE 5
Composition Data for alpha-Spodumene and Leached Residue
Mass Composition by Peroxide Fusion ICP-ES (% wt./wt.)

| Sample | Al | Li |
|---|---|---|
| alpha-spodumene (JD231128 R0) | 13.59 | 3.392 |
| Leached Residue from TBR (JD231128 R2) | 13.55 | 0.775 |

### Example 4

### Hydrothermal Leach of K-Feldspar with NaOH and Subsequent CO₂ Leach of Hydroxycancrinite

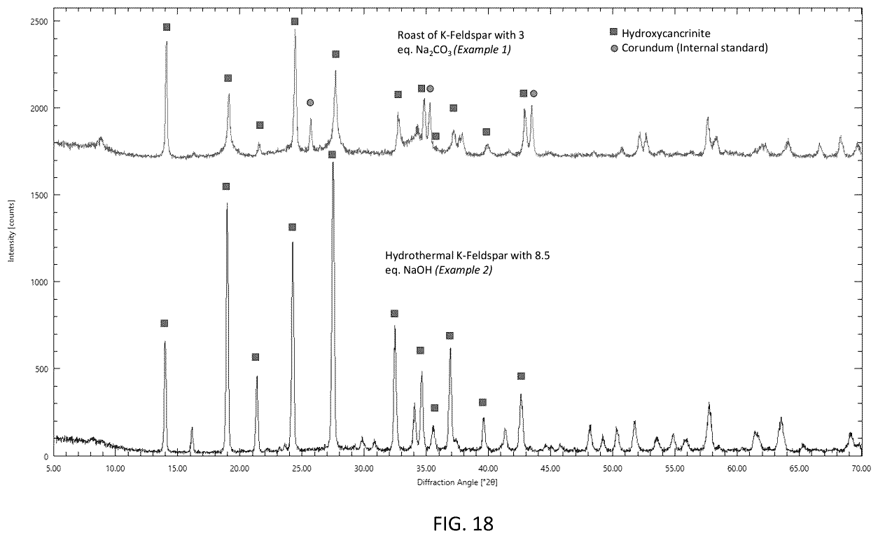

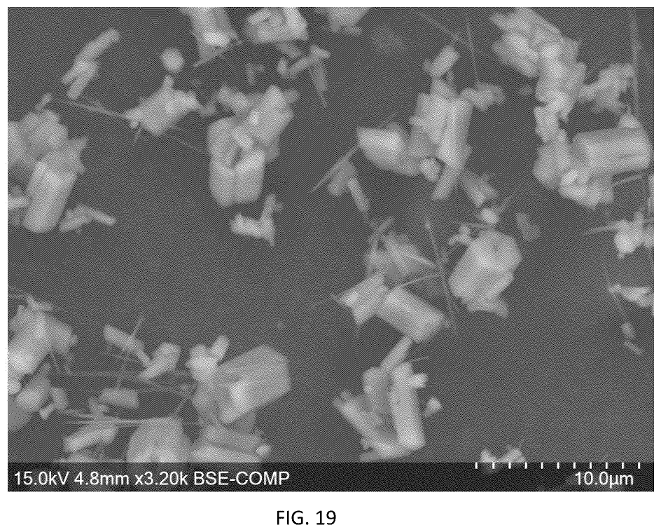

Commercially available potassium feldspar (Custer), milled to a D₅₀ of 8 um, was mixed with a solution comprised of NaOH pellets (>97.0% pure, 8.5 molar equivalents), dissolved in DI water to make up a L/S ratio of 2. The suspension was heated to 250° C. in a PTFE lined autoclave for 3 hours before allowing the mixture to cool to 50° C. and filtering off the residue. The resulting solid (hydroxycancrinite) was rinsed with 2 volumes of DI water and dried overnight in an oven at 105° C. before characterization with XRD (see FIG. 18), SEM (see FIG. 19), and SEM-EDX (see Table 6 below).

TABLE 6
SEM-EDX Data for K-feldspar and Hydrothermally
Leached Residue (hydroxycancrinite)

| Mass Composition by SEM-EDX (% wt/wt) | | | | | | | Total | | |
|---|---|---|---|---|---|---|---|---|---|
| Sample | Al | Na | K | Si | O | Fe | Alkali | Alkali:Al | Si:Al |
| Starting Custer | 7.7 | 2.0 | 5.9 | 36.1 | 47.9 | — | 8.0 | 1.0 | 4.7 |
| K-feldspar | | | | | | | | | |
| Hydrothermal | 14.9 | 17.3 | — | 19.1 | 48.7 | — | 17.3 | 1.2 | 1.3 |
| Hydroxycancrinite | | | | | | | | | |

The above solid residue (hydroxycancrinite) was wet-milled briefly to an average particle size of 10 um before continuing with the identical carbonation procedure to form kaolinite, and then metakaolin. Alkali carbonate recovery and utilization would be performed using the carbonation procedure summarized in Example 1. In this case, recovery of alkali from alkali-silicate could also be achieved with nitric acid to form alkali nitrate—from this, (Na,K)OH and nitric acid would be regenerated electrochemically using known processes.

Finally, inorganic polymer cement and concrete can be formed with aggregate, the alkali-silicate salt, and synthetic metakaolin formed in the above steps.

### Example 5

### Hydrothermal Leach of K-Feldspar with KOH and Subsequent CO₂ Leach of Kalsilite

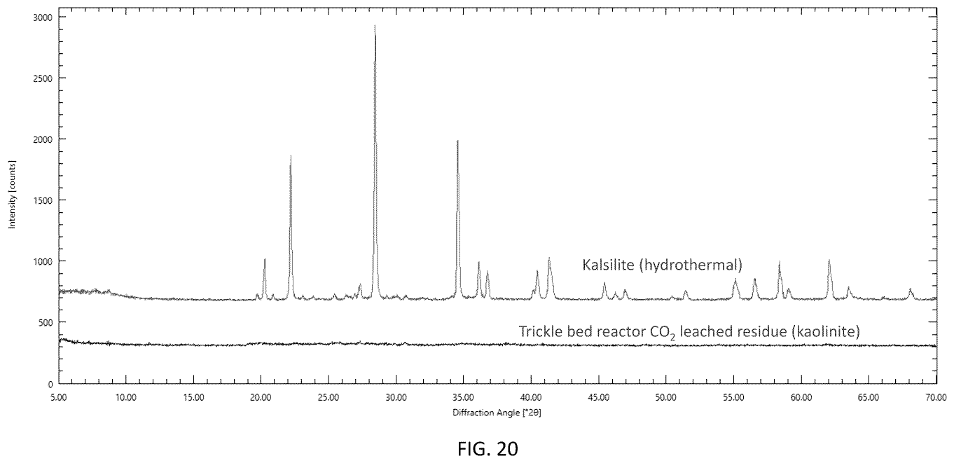

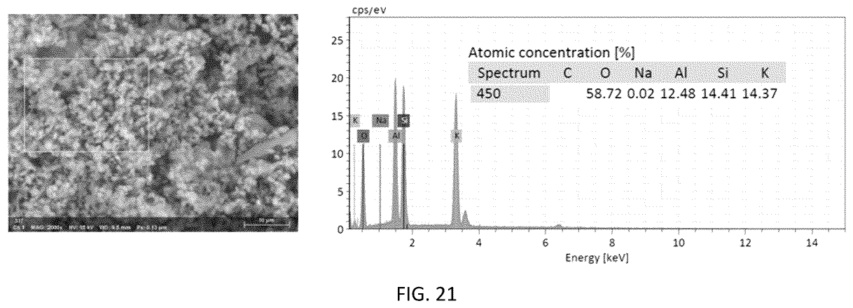

Commercially available potassium feldspar (Custer), milled to a D₅₀ of 8 um, was mixed with a solution comprised of KOH pellets (>85% pure, 8.5 molar equivalents), dissolved in DI water to make up a L/S ratio of 2. The suspension was heated to 250° C. in a PTFE lined autoclave for 3 hours before allowing the mixture to cool to 50° C. and subsequently filtering off the resulting residue and rinsing with 2 volumes of DI water. The resulting solid (kalsilite) was oven dried overnight at 105° C. before characterization with XRD (see FIG. 20), and SEM-EDX (see FIG. 21).

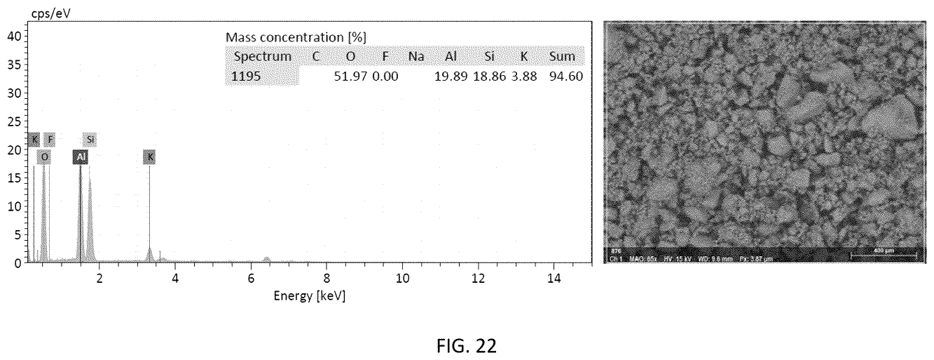

The above solid residue (kalsilite) was wet-milled briefly to an average particle size of 10 um before continuing with the carbonation procedure used in Example 1 to form synthetic kaolinite, and then metakaolin. As an example of potassium extraction by carbonation, the solid residue discussed above [0060] was packed into a continuous flow (trickle-bed) reactor (TBR), and extracted using a variety of parameters: Temperature 150-225° C., reaction time (6-24 hours), water flow rate (0.5-5 ml/minute, and CO₂ pressure (200-1500 psig). The resulting solid was oven dried overnight at 105° C. before characterization with XRD (see FIG. 20), and SEM-EDX (see FIG. 22). Alkali carbonate recovery and utilization would be performed as summarized in Example 2. In this case, recovery of alkali from alkali-silicate could also be achieved with nitric acid to form alkali nitrate—from this, (Na,K)OH and nitric acid would be regenerated electrochemically using known processes.

Finally, inorganic polymer cement and concrete can be formed with aggregate, the alkali-silicate salt, and metakaolin formed in the above steps.

### Example 6

### Hydroxycancrinite (Roast Product) Leach with Nitric Acid, and Recovery of Acid Electrochemically

As with Example 1, commercially available potassium feldspar (Custer), milled to a D₅₀ of 8 um, was well blended with Na₂CO₃ (>99.5% pure, 3 molar equivalents), and heated to 900° C. on a Hastelloy tray for 2 hours in a furnace. The resulting melted product was coarsely milled and extracted in an autoclave with DI water (liquid-to solid ratio range of 1-5) at 240° C. for 6 hours. The residue was rinsed with two-fold this volume of DI water, and the solid was oven dried overnight at 105° C. before characterization with XRD, SEM-EDX, and XRF (Example 1). The liquid extract (sodium silicate) was characterized as quantitative by ICP (Example 1).

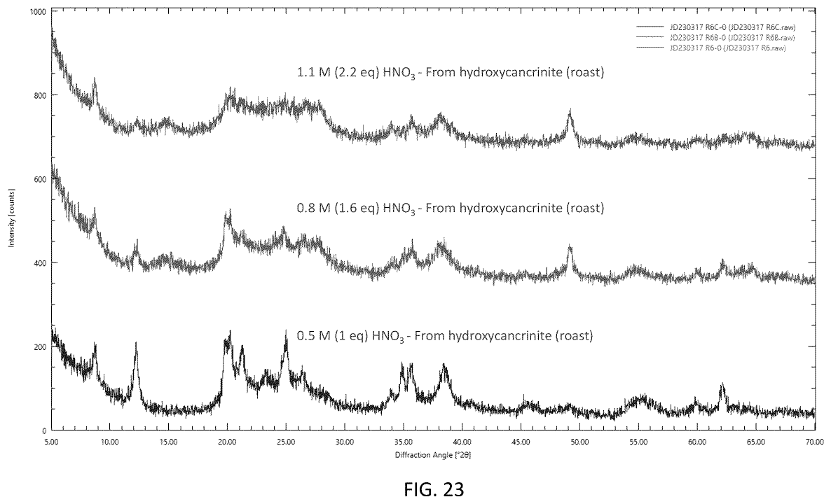

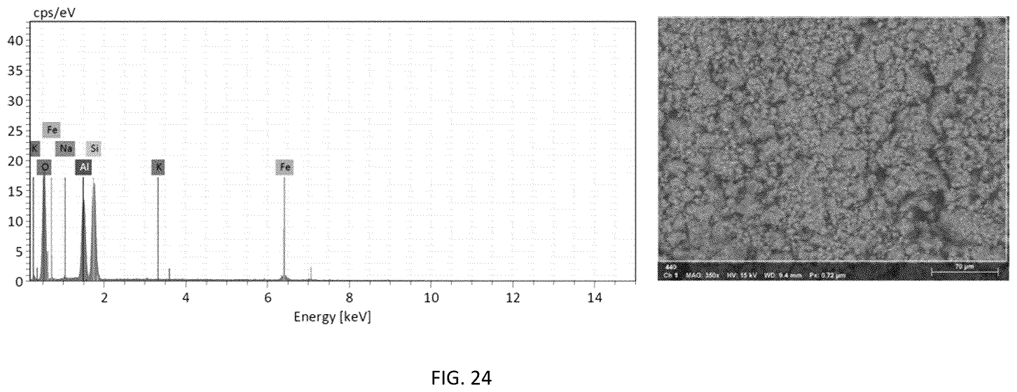

The above solid residue was taken up in 0.8 M (1.6 eq.) nitric acid (L/S ratio of 12) and placed in an autoclave at 240° C. for 15 hours. After cooling to 50° C., the resulting residue was filtered and rinsed with 2 volumes of warm DI water. The resulting solid (synthetic kaolinite) was oven dried overnight at 105° C. before characterization with XRD (see FIG. 23), SEM-EDX (see FIG. 24 and Table 7 below). In this case the total alkali remaining in the leached residue was found to be 0.2%, indicating almost complete alkali extraction.

TABLE 7
SEM-EDX Data for Feldspar, Hydroxycancrinite, and Product (Synthetic
Kaolinite) Formed by Leaching of Hydroxycancrinite with Various
Nitric Acid Concentrations (1.1M, 0.8M, and 0.5M)

| Mass Composition by SEM-EDX (% wt/wt) | | | | | | | Total | | |
|---|---|---|---|---|---|---|---|---|---|
| Sample | Al | Na | K | Si | O | Fe | Alkali | Alkali:Al | Si:Al |
| Starting Custer | 7.7 | 2.0 | 5.9 | 36.1 | 47.9 | — | 8.0 | 1.0 | 4.7 |
| K-feldspar | | | | | | | | | |
| Hydroxycancrinite | 15.7 | 16.1 | 1.5 | 18.8 | 47.8 | — | 17.6 | 1.1 | 1.2 |
| from roast | | | | | | | | | |
| Leached Residue | 15.2 | — | — | 28.1 | 56.7 | — | — | — | 1.8 |
| (1.1M HNO₃) | | | | | | | | | |
| Leached Residue | 18.4 | 0.0 | 0.2 | 22.9 | 58.5 | — | 0.2 | 0.0 | 1.3 |
| (0.8M HNO₃) | | | | | | | | | |
| Leached Residue | 18.5 | 0.6 | 0.9 | 22.5 | 57.4 | — | 1.4 | 0.1 | 1.2 |
| (0.5M HNO₃) | | | | | | | | | |

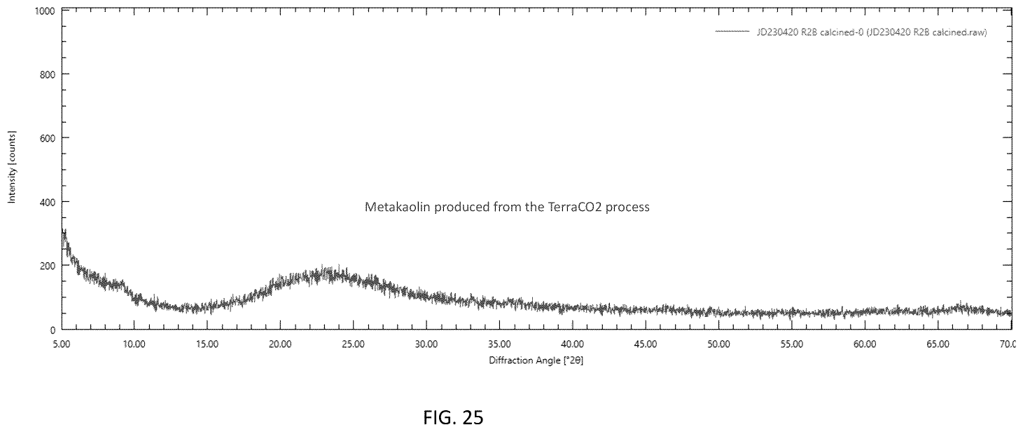

As described in Example 1, the fully leached solid residue (synthetic kaolinite) was milled to an average particle size of 10 um before further activation by calcination at 775° C. in a furnace for 1.5 hours, with a 1.5-hour ramp-up, and ramp-down time. This product was characterized by XRD (see FIG. 25) and used as a source of metakaolin for inorganic polymer applications without further processing.

In this case, recovery of alkali from alkali-silicate could also be achieved with nitric acid to form alkali nitrate—from this, (Na,K)OH and nitric acid would be regenerated electrochemically using known processes.

Finally, inorganic polymer cement and concrete can be formed with aggregate, the alkali-silicate salt, and metakaolin formed in the above steps.

### Example 7

### Hydroxycancrinite (Hydrothermal Product) Leach with Nitric Acid, and Recovery of Acid Electrochemically

As with Example 2, commercially available potassium feldspar (Custer), milled to a D₅₀ of 8 um, was mixed with a solution comprised of NaOH pellets (>97.0% pure, 8.5 molar equivalents), dissolved in DI water to make up a L/S ratio of 2. The suspension was heated to 250° C. in a PTFE lined autoclave for 3 hours before allowing the mixture to cool to 50° C. before filtering off the resulting residue and rinsing with 2 volumes of DI water. The resulting solid was oven dried overnight at 105° C. before characterization with XRD, and SEM-EDX (See Example 2).

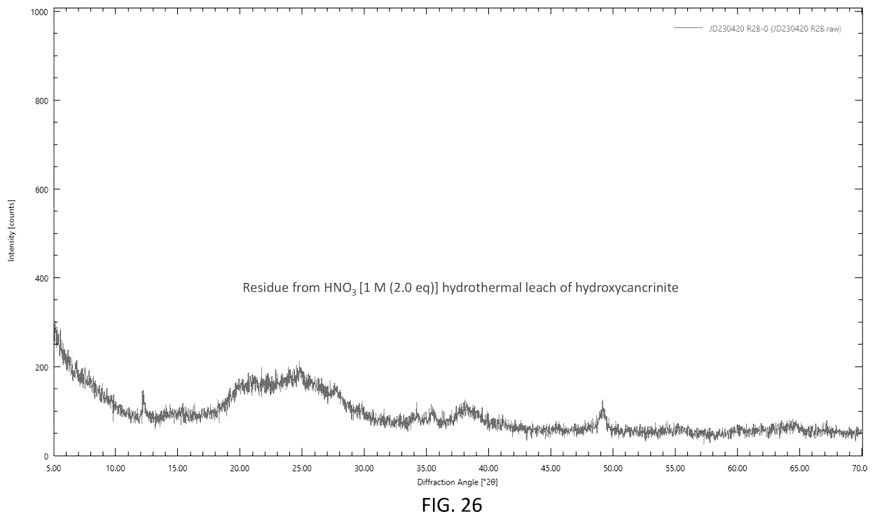

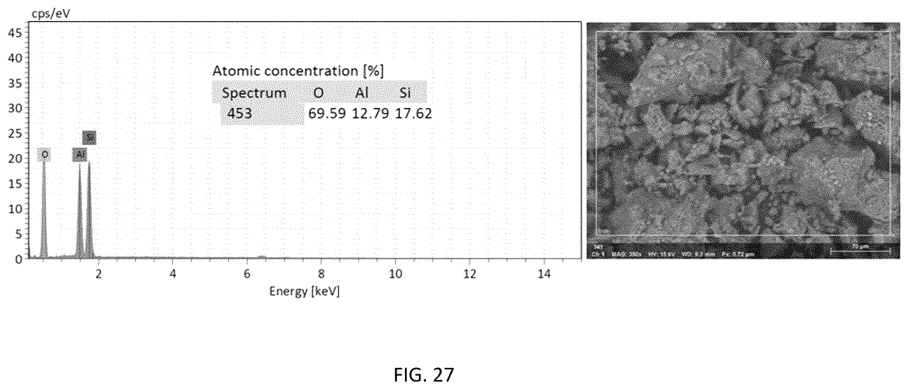

The above solid residue was taken up in 1 M (2 eq.) nitric acid (L/S ratio of 12) and placed in an autoclave at 240° C. for 15 hours. After cooling to 50° C., the resulting residue was filtered and rinsed with 2 volumes of warm DI water. The resulting solid was oven dried overnight at 105° C. before characterization with XRD (see FIG. 26), SEM-EDX (see FIG. 27). In this case the total alkali remaining was not detected (i.e. 0%). As described in Example 1, metakaolin can be formed by calcination of this residue.

In this case, recovery of alkali from alkali-silicate would also be achieved with nitric acid to form alkali nitrate—from this, (Na,K)OH and nitric acid would be regenerated electrochemically using known processes.

Finally, inorganic polymer cement and concrete can be formed with aggregate, the alkali-silicate salt, and metakaolin formed in the above steps.

### Example 8

### Kalsilite (Hydrothermal Product) Leach with Nitric Acid, and Recovery of Acid Electrochemically

As with Example 3, Commercially available potassium feldspar (Custer), milled to a D₅₀ of 8 um, was mixed with a solution comprised of KOH pellets (>85% pure, 8.5 molar equivalents), dissolved in DI water to make up a L/S ratio of 2. The suspension was heated to 250° C. in a PTFE lined autoclave for 3 hours before allowing the mixture to cool to 50° C. before filtering off the resulting residue and rinsing with 2 volumes of DI water. The resulting solid was oven dried overnight at 105° C. before characterization with XRD, and SEM-EDX (See Example 2).

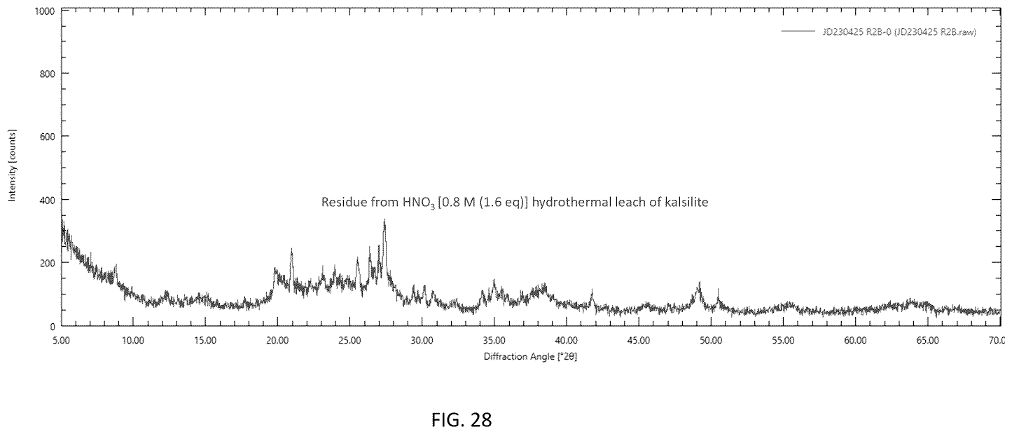

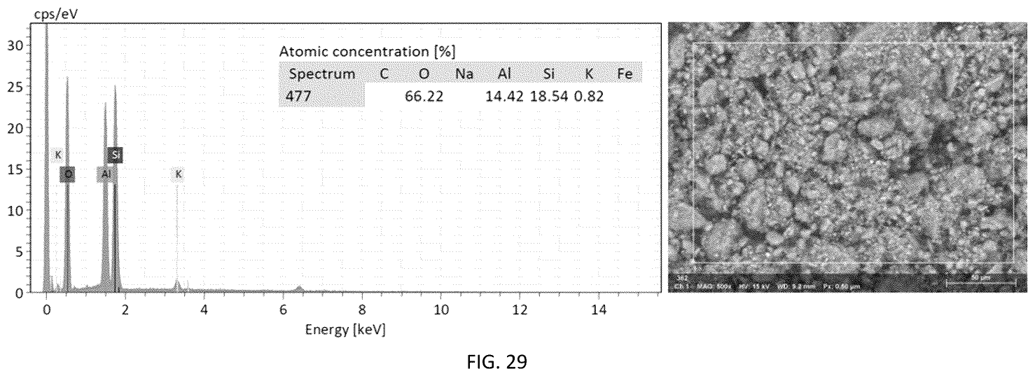

The above solid residue was taken up in 0.8 M (1.6 eq.) nitric acid (L/S ratio of 12) and placed in an autoclave at 240° C. for 15 hours. After cooling to 50° C., the resulting residue was filtered and rinsed with 2 volumes of warm DI water. The resulting solid was oven dried overnight at 105° C. before characterization with XRD (see FIG. 28), SEM-EDX (see FIG. 29). In this case the total alkali remaining was 0.82%. As described in Example 1, metakaolin can be formed by calcination of this residue.

In this case, recovery of alkali from alkali-silicate would also be achieved with nitric acid to form alkali nitrate—from this, (Na/K)OH and nitric acid would be regenerated electrochemically using known processes.

Finally, inorganic polymer cement and concrete can be formed with aggregate, the alkali-silicate salt, and metakaolin formed in the above steps.

### Example 9

### Highly Reactive Binders Formed with Commercial Potassium Silicate and Synthetic Metakaolin Produced by the TerraCO2 Process

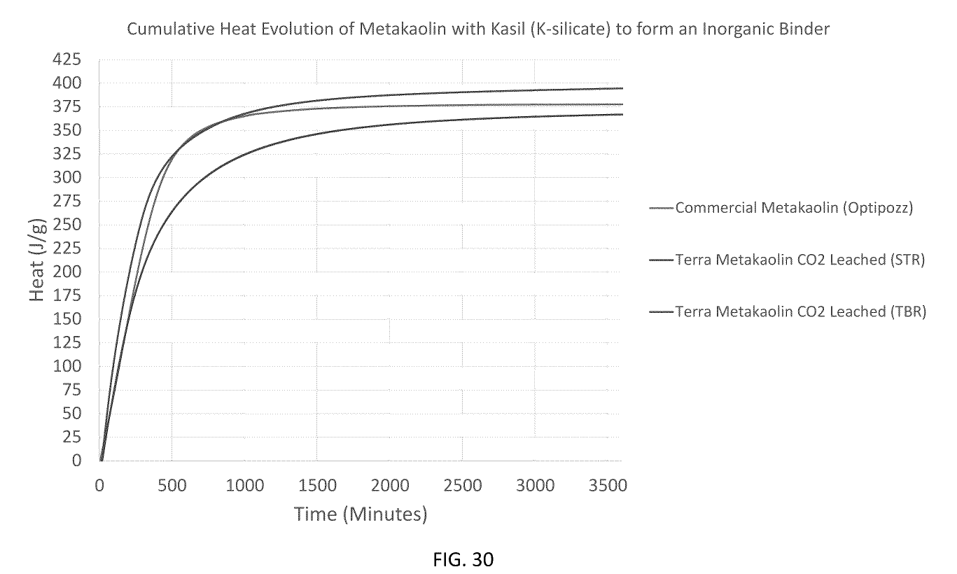

1 g of metakaolin produced by CO₂ leaching, such as those formed in Example 1 (calcined at 775° C.), were vortexed for 30 seconds with 1.8 g of K-silicate (1.7 molar ratio) before measuring the heat evolution by isothermal calorimetry at 40° C. A commercially available metakaolin (OptiPozz) that is known to perform well in inorganic polymer binders, was also prepared and measured in the same way for comparison. Shown in FIG. 30 is the total heat evolved over time for these CO₂ leached samples. As anticipated, after calcination 775° C., both the stirred reactor and trickle-bed reactor synthetic metakaolin samples produced in Example 1 had comparable, or higher total heat evolved when compared to the commercial metakaolin (OptiPozz).

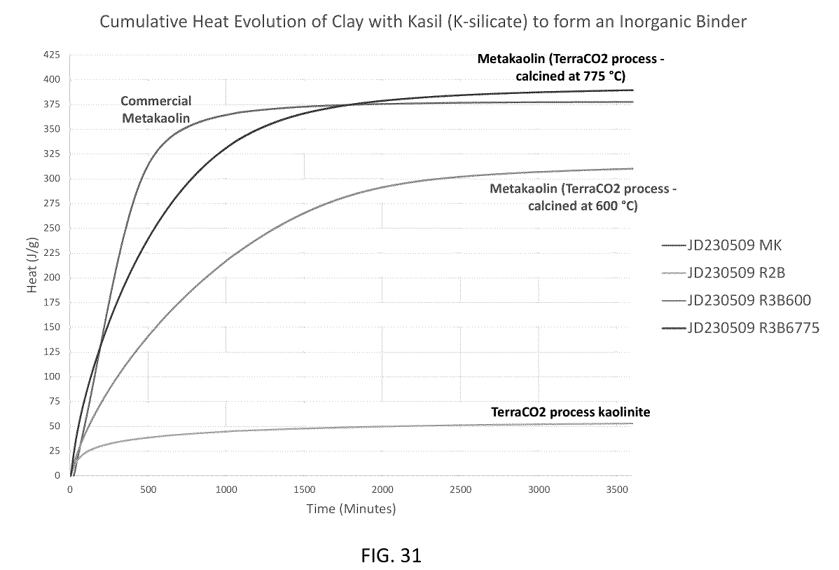

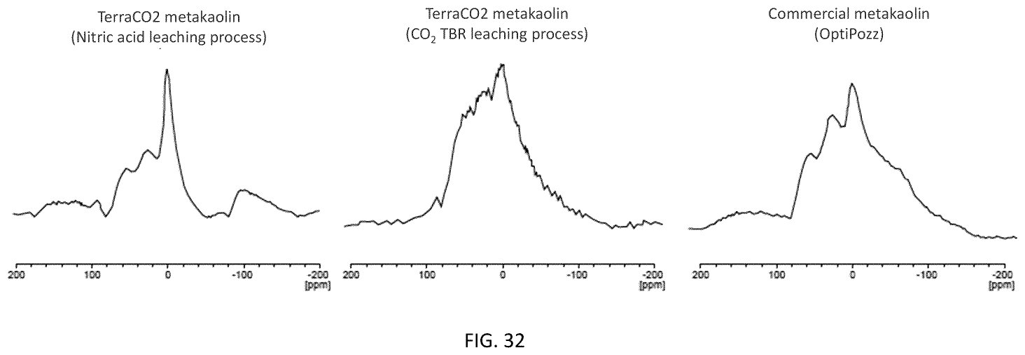

1 g of synthetic kaolinite or metakaolin produced by acid leaching, such as those formed in Example 4 (calcined at either 600° C. or 775° C.), were vortexed for 30 seconds with 1.8 g of K-silicate (1.7 molar ratio) before measuring the heat evolution by isothermal calorimetry at 40° C. A commercially available metakaolin (OptiPozz) that is known to perform well in inorganic polymer binders, was also prepared and measured in the same way for comparison. Shown in FIG. 31 is the total heat evolved over time for these acid leached samples. As anticipated, both metakaolin samples produced in Example 4 had a higher total heat evolution than the precursor synthetic kaolinite, with the sample calcined at 775° C. being higher than that calcined at 600° C. Also note that the synthetic metakaolin calcined at 775° C. had a slightly higher total heat when compared to the commercial metakaolin. To provide further evidence that the synthetic metakaolin produced in this example has a similar atomic structure to OptiPozz, 27-Aluminum Magic Spin Angle Solid State NMR (Al²⁷ MAS SS NMR) was used to compare the two samples Shown in FIG. 32 are 27-Al NMR spectra that suggest a similar distribution of Al coordination (Note: the chemical shifts (in ppm) of coordination states IV, V, and VI are around 57 ppm, 28 ppm, and 0 ppm, respectively).

Advantages of one or more embodiments include, but are not limited to:

Ubiquitous feldspar feedstock allows decentralized production in most regions globally, whereas natural sodium carbonate deposits are very isolated geographically and tightly controlled, requiring long shipping distances.

No process CO₂ resulting from raw alkali silicate feedstock (instead of alkali carbonate feedstock).

Closed loop process, aligned with green chemistry: acids are regenerated (e.g. CO₂/carbonic acid loop and nitrate/nitric acid loop).

Coproduct Al—Si (synthetic kaolinite or metakaolin) is also a valuable reagent for inorganic polymer.

Excess silica gel is a valuable coproduct.

Electrified energy sources or other zero-CO₂ sources of energy can also be used to power the processes described in these embodiments. The use of green energy sources, including but not limited to, hydroelectric, solar, and wind power greatly reduce the GHG emissions of the overall process. These energy sources can be used to power every aspect of the supply chain, including transportation, potentially leading to complete decarbonization of the production process.

In one embodiment, a granitic rock (or any feldspar-bearing rock) may be used to produce all the components of an inorganic polymer concrete in an efficient manner (FIG. 1). In such an example, cement production and aggregate production may be integrated into one operation if locally advantageous and because aggregate is the main component of concrete, the amount of aggregate production will always greatly exceed the cement needed. The magnitude of aggregate diverted for cement production need only be a minor amount of an existing mine's production. Additionally, the process of crushing and grading aggregates at a mine rarely produces an optimal balance of graded products to suit the local market—in part this may be due to limitations of comminution equipment. The present process may present an opportunity to enhance the value of a portion of a lower value aggregate fines stream and thereby maximize the value of mined materials from an aggregate operation.

For example, to produce 1 m³ of concrete from typical granitic rock, 4.6 tons of granite (˜1.7 m³) may be used as feedstock to yield 1.85 tons of graded fine and coarse concrete aggregate, ˜0.37 tons of cementitious materials (according to present method), and 2.4 tons of extra aggregate products not used in the concrete. This is one example of how a minimum quantity of natural resources could be used to produce a concrete.

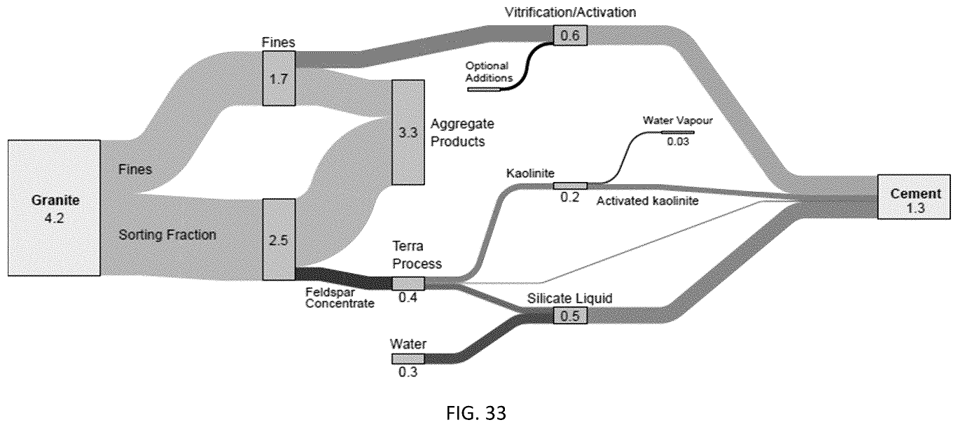

Considering only cement production (FIG. 33), an input of 4.2 tons of typical granite will yield approximately 3.2 tons of aggregate product (mostly non-alkali-bearing fraction) and 1 dry ton of inorganic polymer cement.

An input of a typical 1 ton of sodium feldspar yields approximately 0.46 tons kaolinite, 0.20 tons sodium carbonate, and 1.8 tons silica (gel or other form).

In one embodiment, the feedstock may be an alkali-rich product of another industrial process. For instance, analcime-rich waste byproduct of lithium extraction from lithium silicate minerals.

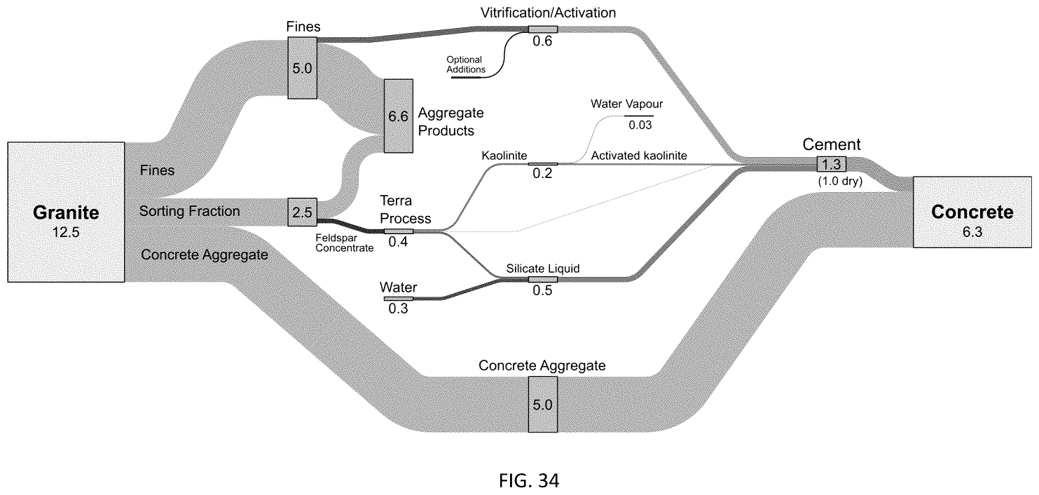

In one embodiment, the feedstock for making inorganic polymer cement is an inorganic polymer cement (or concrete) of suitable alkali aluminosilicate composition. In one version the concrete aggregate has a similar composition as the binder. In another version the aggregates are a different composition than the binder, but may be separated during recycling in order to make two waste streams (one that is mostly binder and another that is mostly aggregates). In this way, the feedstock for cement may consist of recycled cement or concrete from construction and demolition waste. Thus, concrete production may be a fully circular process using a minimum of energy and resources to demolish, regenerate, and recast structures as needed. One non-limiting example of such a system is shown in FIG. 34 and reinforces the cyclical potential of the process; the same concept applies to a potassium-based system and mixed sodium-potassium systems.

In one embodiment, the alkali, silica, and kaolinite-like products are used to make an inorganic polymer cement for use in ready-mix concrete, precast concrete, a pavement, waste encapsulation or stabilization, well cementing, or physical and chemical stabilization of waste materials.

In one embodiment, the products of the process are used to make concrete:

Various aspects of the present disclosure are also described in the numbered clauses set forth below:

Clause 1. A method for extracting potassium, sodium, or both potassium and sodium from silicates under carbon neutral conditions, said method comprising: (a) providing a reaction mixture comprising a first reactant and a second reactant, wherein the first reactant comprises a potassium-bearing aluminosilicate composition, a sodium-bearing aluminosilicate composition, or a mixture thereof, and wherein the second reactant comprises a corresponding potassium base composition, sodium base composition, or a mixture thereof; (b) treating the reaction mixture with a combined activation and leaching process to form a concentrated potassium-silicate solution, sodium-silicate solution, or mixture thereof and a corresponding potassium aluminosilicate solid residue, sodium aluminosilicate solid residue, or mixture thereof, wherein carbon dioxide is produced as a carbon dioxide reusable co-product from the activation; and (c) reacting the potassium aluminosilicate solid residue, the sodium aluminosilicate solid residue, or the mixture thereof with a first portion of the carbon dioxide reusable co-product to form a potassium leached aluminosilicate composition, a sodium leached aluminosilicate composition, or a mixture thereof, thereby extracting potassium, sodium, or a mixture thereof from the corresponding potassium-bearing aluminosilicate composition, sodium-bearing aluminosilicate composition, or mixture thereof.

Clause 2. The method according to Clause 1, wherein the activation process is selected from the group consisting of thermal, hydrothermal, chemical, mechanochemical, irradiative, electromagnetic, and electrochemical activation.

Clause 3. The method according to Clause 2, wherein the heating comprises heating at a temperature ranging from about 850° C.-1100° C., about 900° C.-1050° C., or about 950° C.-1000° C., with a residence time ranging from about 0.25-4 hours, about 0.5-1.5 hours, or about 0.75-1.25 hours.

Clause 4. The method according to Clause 2, wherein the activation process is a hydrothermal process and wherein the hydrothermal process comprises heating at a temperature ranging from about 150° C.-275° C., about 175° C.-250° C., or about 200° C.-225° C. with a residence time ranging from about 1-72 hours, about 8-24 hours, or about 12-18 hours.

Clause 5. The method according to Clause 1, wherein the potassium-bearing aluminosilicate composition and the sodium-bearing aluminosilicate composition comprise feldspars.

Clause 6. The method according to Clause 5, wherein the feldspar is selected from the group consisting of alkali feldspar and plagioclase feldspar.

Clause 7. The method according to Clause 5, wherein the feldspar is selected from the group consisting of orthoclase, sanidine, microcline, anorthoclase, albite, oligoclase, andesine, labradorite, bytownite, anorthite, and mixtures or solid solutions thereof.

Clause 8. The method according to Clause 1, wherein the potassium-bearing aluminosilicate composition and the sodium-bearing aluminosilicate composition comprise feldspathoid minerals selected from the group consisting of nepheline, kalsilite, sodalite, leucite, haüyne, cancrinite, and the like.

Clause 9. The method according to Clause 1, wherein the potassium-bearing aluminosilicate composition and the sodium-bearing aluminosilicate composition comprise zeolite supergroup minerals comprising zeolites selected from the group consisting of analcime, chabazite, clinoptilolite, erionite, mordenite, phillipsite, ferrierite, natrolite, faujasite, and the like.

Clause 10. The method according to Clause 1, wherein the potassium-bearing aluminosilicate composition and the sodium-bearing aluminosilicate composition comprise mica group and clay group minerals, wherein the mica and clay minerals are selected from the group consisting of muscovite, biotite, phlogopite, smectite, illite, vermiculite, saponite, lepidolite, hectorite, and the like.

Clause 11. The method according to Clause 1, wherein the potassium base composition comprises is selected from the group consisting of potassium (K), potassium hydroxide (KOH), potassium carbonate (K₂CO₃), potassium oxide (K₂O), and mixtures thereof.

Clause 12. The method according to Clause 1, wherein the sodium base composition comprises is selected from the group consisting of sodium (Na), sodium hydroxide (NaOH), sodium carbonate (Na₂CO₃), sodium oxide (Na₂O), and mixtures thereof.

Clause 13. The method according to Clause 1, wherein the mixture of the potassium base composition and the sodium base composition comprises a mixture of two or more of compositions selected from the group consisting of potassium (K), potassium hydroxide (KOH), potassium carbonate (K₂CO₃), potassium oxide (K₂O), sodium (Na), sodium hydroxide (NaOH), sodium carbonate (Na₂CO₃), sodium oxide (Na₂O), and mixtures thereof.

Clause 14. The method according to Clause 1, wherein the potassium aluminosilicate solid residue, sodium aluminosilicate solid residue, or mixture thereof produced from the treating step has a silicon/aluminum (Si:Al) ratio ranging from about 0.8-1.8.

Clause 15. The method according to Clause 1, wherein the reacting step is conducted at a temperature ranging from about 150° C.-500° C., about 175° C.-225° C., or about 185° C.-210° C., at a pressure ranging from about 0-1500 pounds per square inch gauge (psig), about 50-600 psig, or about 100-300 psig for a period of time sufficient to leach substantially all remaining alkali into an alkali metal solution having a formula of M₂CO₃, wherein M is a corresponding alkali metal.

Clause 16. The method according to Clause 1, wherein the carbon dioxide produced from the method is substantially reused.

Clause 17. A composition comprising a potassium, sodium, or potassium and sodium leached aluminosilicate composition produced according to the method of any one of Clauses 1-16.

Clause 18. A composition comprising a potassium, sodium, or potassium and sodium composition produced according to the method of any one of Clauses 1-16.

Clause 19. A composition comprising an alkali product produced according to the method of any one of Clauses 1-16, wherein the alkali product is selected from the group consisting of alkali carbonate, alkali silicate, and the like.

Clause 20. A method for extracting alkali from silicates, with concurrent formation of an activated synthetic kaolinite composition under carbon neutral conditions, said method comprising: (a) providing a reaction mixture comprising an alkali-bearing aluminosilicate composition and an alkali base composition; (b) treating the reaction mixture with a combined activation and leaching process to form a concentrated alkali-silicate solution and an alkali aluminosilicate solid residue, wherein carbon dioxide is produced as a carbon dioxide reusable co-product from the activation; (c) reacting the alkali aluminosilicate solid residue with a first portion of the carbon dioxide reusable co-product to form an alkali leached aluminosilicate composition, thereby extracting alkali from the alkali-bearing aluminosilicate composition; and (d) activating the alkali leached aluminosilicate composition to form an activated synthetic kaolinite composition.

Clause 21. The method according to Clause 20, wherein the activating comprises a process of increasing reactivity selected from the group consisting of thermal, chemical, irradiation, electromagnetic, electrochemical, and mechanical energy processes.

Clause 22. The method according to Clause 20, wherein the activated synthetic kaolinite composition comprises metakaolin, vitrified kaolinite, calcined kaolinite, flash calcined kaolinite, activated clay with an Si:Al ratio ranging from about 0.5-1.5, or combinations thereof.

Clause 23. The method according to Clause 20, wherein the carbon dioxide produced from the method is substantially reused.

Clause 24. The method according to Clause 20, wherein the reacting step is conducted at a temperature ranging from about 150° C.-500° C., about 175° C.-225° C., or about 185° C.-210° C., at a pressure ranging from about 0-1500 pounds per square inch gauge (psig), about 50-600 psig, or about 100-300 psig for a period of time sufficient to leach substantially all remaining alkali into an alkali metal solution having a formula selected from the group consisting of M₂CO₃, MOH, and M₂O, wherein M is a corresponding alkali metal.

Clause 25. The method according to Clause 24, further comprising: concentrating, crystalizing, isolating, and/or transforming the alkali metal solution to form an alkali metal solid having a formula selected from the group consisting of M₂CO₃, MOH, and M₂O, wherein M is a corresponding alkali metal.

Clause 26. The method according to Clause 25, further comprising: re-introducing at least a portion of the alkali metal solid into the treating step as the alkali base composition, thereby forming a continuous loop of alkali base composition production and consumption.

Clause 27. The method according to Clause 20, further comprising: reacting the concentrated alkali-silicate solution with a second portion of the carbon dioxide reusable co-product to form a solid silica gel and an alkali-carbonate solution.

Clause 28. The method according to Clause 27, wherein the solid silica gel comprises silica (SiO₂) at a concentration ranging from about 75-100 wt %.

Clause 29. The method according to Clause 27, wherein the solid silica gel is reused for reacting or combining with the alkali base composition to form alkali silicate or as activated silica source for inorganic polymer cement production, or wherein the solid silica gel is reused for reacting or combining with an alkali-silicate composition.

Clause 30. The method according to Clause 27, wherein the alkali-carbonate solution comprises M₂CO₃, at concentration ranging from 1-40 wt/wt % M₂CO₃ in water, wherein M is a corresponding alkali metal.

Clause 31. The method according to Clause 27, further comprising: isolating an alkali carbonate composition from the alkali-carbonate solution; and combining the solid silica gel and the isolated alkali carbonate composition to form an alkali-silicate liquid.

Clause 32. The method according to Clause 31, wherein the alkali-silicate liquid comprises silica (SiO₂) at a concentration ranging from about 10-50 wt % and comprises a weight ratio of SiO₂:M₂O ranging from about 1.0-4.0.

Clause 33. The method according to Clause 31, further comprising: treating the alkali-silicate liquid to form an isolated alkali-silicate solid product.

Clause 34. A composition comprising an activated synthetic kaolinite composition produced according to the method of any one of Clauses 20-23.

Clause 35. A composition comprising an alkali carbonate liquid produced according to any of Clauses 20-23.

Clause 36. A composition comprising solid product produced according to any of Clauses 20-23.

Clause 37. A composition comprising an alkali-silicate liquid produced according to the method of any one of Clauses 31-32.

Clause 38. A composition comprising an alkali-silicate solid product produced according to the method of Clause 33.

Clause 39. A method of preparing inorganic polymer cement, comprising: providing an activated synthetic kaolinite composition produced according to the method of Clause 20; and using the activated synthetic kaolinite composition as a reagent to form inorganic polymer cement.

Clause 40. A composition comprising an inorganic polymer cement produced according to the method of Clause 39.

Clause 41. A method of preparing inorganic polymer concrete, said method comprising: providing an inorganic polymer cement according to Clause 40; and combining the inorganic polymer cement with a solid aggregate composition and an optional filler composition, thereby forming an inorganic polymer concrete, wherein the inorganic polymer is present in an amount ranging from 1-44 weight percent (wt %), the solid aggregate composition is present in an amount ranging from 55-95 wt %, and the optional filler composition is present in an amount ranging from 1-20 wt % of the inorganic polymer concrete.

Clause 42. The method according to Clause 41, wherein the optional filler composition is selected from the group consisting of a reactive filler, an inert filler, and combinations thereof.

Clause 43. The method according to Clause 41, wherein the solid aggregate composition is selected from the group consisting of coarse, intermediate, fine, lightweight, engineered, manufactured, angular, rounded, water-worn, recycled, stone, sand, natural rock, industrial byproducts, alkali aluminosilicate, feldspar, and the like.

Clause 44. A composition comprising an inorganic polymer concrete produced according to the method of any one of Clauses 41-43.

Clause 45. A method for extracting alkali from alkali-bearing silicates under carbon neutral conditions, said method comprising: (a) providing a reaction mixture comprising an alkali-bearing aluminosilicate composition and an alkali base composition that comprises the alkali contained in the alkali-bearing aluminosilicate; (b) treating the reaction mixture with a combined activation and leaching process to form a concentrated alkali-silicate solution and an alkali aluminosilicate solid residue, wherein carbon dioxide is produced as a carbon dioxide reusable co-product from the activation; and (c) reacting the alkali aluminosilicate solid residue with a first portion of the carbon dioxide reusable co-product to form an alkali leached aluminosilicate composition, thereby extracting alkali from the alkali-bearing aluminosilicate composition.

Clause 46. The method according to Clause 45, wherein the activation process is selected from the group consisting of thermal, hydrothermal, chemical, mechanochemical, irradiative, electromagnetic, and electrochemical activation.

Clause 47. The method according to Clause 46, wherein the heating comprises heating at a temperature ranging from about 850° C.-1100° C., about 900° C.-1050° C., or about 950° C.-1000° C., with a residence time ranging from about 0.25-4 hours, about 0.5-1.5 hours, or about 0.75-1.25 hours.

Clause 48. The method according to Clause 46, wherein the activation process is a hydrothermal process and wherein the hydrothermal process comprises heating at a temperature ranging from about 150° C.-275° C., about 175° C.-250° C., or about 200° C.-225° C., with a residence time ranging from about 1-72 hours, about 8-24 hours, or about 12-18 hours.

Clause 49. The method according to Clause 45, wherein the alkali-bearing aluminosilicate composition comprises feldspar.

Clause 50. The method according to Clause 49, wherein the feldspar is selected from the group consisting of alkali feldspar and plagioclase feldspar.

Clause 51. The method according to Clause 49, wherein the feldspar is selected from the group consisting of orthoclase, sanidine, microcline, anorthoclase, albite, oligoclase, andesine, labradorite, bytownite, anorthite, and mixtures or solid solutions thereof.

Clause 52. The method according to Clause 45, wherein the alkali-bearing aluminosilicate composition comprises feldspathoid minerals selected from the group consisting of nepheline, kalsilite, sodalite, leucite, haüyne, cancrinite, and the like.

Clause 53. The method according to Clause 45, wherein the alkali-bearing aluminosilicate composition comprises zeolite supergroup minerals comprising zeolites selected from the group consisting of analcime, chabazite, clinoptilolite, erionite, mordenite, phillipsite, ferrierite, natrolite, faujasite, and the like.

Clause 54. The method according to Clause 45, wherein the alkali-bearing aluminosilicate composition comprises mica group and clay group minerals, wherein the mica and clay minerals are selected from the group consisting of muscovite, biotite, phlogopite, smectite, illite, vermiculite, saponite, lepidolite, hectorite, and the like.

Clause 55. The method according to Clause 45, wherein the alkali-bearing aluminosilicate composition comprises spodumene, petalite, hectorite, eucryptite, and/or jadarite.

Clause 56. The method according to Clause 45, wherein the alkali base composition comprises an alkali metal selected from the group consisting of sodium (Na), potassium (K), lithium (Li), and mixtures thereof.

Clause 57. The method according to Clause 45, wherein the alkali base composition is selected from the group consisting of sodium hydroxide (NaOH), potassium hydroxide (KOH), lithium hydroxide (LiOH), and mixtures thereof.

Clause 58. The method according to Clause 45, wherein the alkali base composition is selected from the group consisting of sodium carbonate (Na₂CO₃), potassium carbonate (K₂CO₃), lithium carbonate (Li₂CO₃), and mixtures thereof.

Clause 59. The method according to Clause 45, wherein the alkali base composition is selected from the group consisting of sodium oxide (Na₂O), potassium oxide (K₂O), lithium oxide (Li₂O), and mixtures thereof.

Clause 60. The method according to Clause 45, wherein the alkali base composition is selected from the group consisting of sodium bicarbonate (NaHCO₃), potassium bicarbonate (KHCO₃), lithium bicarbonate (LiHCO₃), and mixtures thereof.

Clause 61. The method according to Clause 45, wherein the alkali aluminosilicate solid residue produced from the treating step has a silicon/aluminum (Si:Al) ratio ranging from about 0.8-1.8.

Clause 62. The method according to Clause 45, wherein the reacting step is conducted at a temperature ranging from about 150° C.-500° C., about 175° C.-225° C., or about 185° C.-210° C., at a pressure ranging from 0-1500 pounds per square inch gauge (psig), about 50-600 psig, or about 100-300 psig for a period of time sufficient to leach substantially all remaining alkali into an alkali metal solution having a formula selected from the group consisting of M2CO3, MOH, and M2O, wherein M is a corresponding alkali metal.

Clause 63. The method according to Clause 45, wherein the carbon dioxide produced from the method is substantially reused.

Clause 64. A composition comprising an alkali leached aluminosilicate composition produced according to the method of any one of Clauses 45-63.

Headings are included herein for reference and to aid in locating certain sections. These headings are not intended to limit the scope of the concepts described therein, and these concepts may have applicability in other sections throughout the entire specification. Thus, the present disclosure is not intended to be limited to the embodiments shown herein but is to be accorded the widest scope consistent with the principles and novel features disclosed herein.

The singular forms “a”, “an” and “the” include corresponding plural references unless the context clearly dictates otherwise.

Unless otherwise indicated, all numbers expressing quantities of ingredients, reaction conditions, concentrations, properties, and so forth used in the specification and claims are to be understood as being modified in all instances by the term “about”. At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in the specific examples are reported as precisely as possible. Any numerical value, however, inherently contains certain errors resulting from variations in experiments, testing measurements, statistical analyses and such.

It is understood that the examples and embodiments described herein are for illustrative purposes only and that various modifications or changes in light thereof will be suggested to persons skilled in the art and are to be included within the present disclosure and scope of the appended claims. A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A method for extracting potassium, sodium, or both potassium and sodium from silicates under carbon neutral conditions, said method comprising:
(a) providing a reaction mixture comprising a first reactant and a second reactant, wherein the first reactant comprises a potassium-bearing aluminosilicate composition, a sodium-bearing aluminosilicate composition, or a mixture thereof, and wherein the second reactant comprises a corresponding potassium base composition, sodium base composition, or a mixture thereof;
(b) treating the reaction mixture with a combined activation and leaching process to form a concentrated potassium-silicate solution, sodium-silicate solution, or mixture thereof and a corresponding potassium aluminosilicate solid residue, sodium aluminosilicate solid residue, or mixture thereof, wherein carbon dioxide is produced as a carbon dioxide reusable co-product from the activation; and
(c) reacting the potassium aluminosilicate solid residue, the sodium aluminosilicate solid residue, or the mixture thereof with a first portion of the carbon dioxide reusable co-product to form a potassium leached aluminosilicate composition, a sodium leached aluminosilicate composition, or a mixture thereof, thereby extracting potassium, sodium, or a mixture thereof from the corresponding potassium-bearing aluminosilicate composition, sodium-bearing aluminosilicate composition, or mixture thereof.

2. The method according to claim 1, wherein the activation process is selected from the group consisting of thermal, hydrothermal, chemical, mechanochemical, irradiative, electromagnetic, and electrochemical activation.

3. The method according to claim 2, wherein the heating comprises heating at a temperature ranging from about 850° C.-1100° C., about 900° C.-1050° C., or about 950° C.-1000° C., with a residence time ranging from about 0.25-4 hours, about 0.5-1.5 hours, or about 0.75-1.25 hours.

4. The method according to claim 2, wherein the activation process is a hydrothermal process and wherein the hydrothermal process comprises heating at a temperature ranging from about 150° C.-275° C., about 175° C.-250° C., or about 200° C.-225° C. with a residence time ranging from about 1-72 hours, about 8-24 hours, or about 12-18 hours.

5. The method according to claim 1, wherein the potassium-bearing aluminosilicate composition and the sodium-bearing aluminosilicate composition comprise feldspars.

6. The method according to claim 5, wherein the feldspar is selected from the group consisting of alkali feldspar and plagioclase feldspar.

7. The method according to claim 5, wherein the feldspar is selected from the group consisting of orthoclase, sanidine, microcline, anorthoclase, albite, oligoclase, andesine, labradorite, bytownite, anorthite, and mixtures or solid solutions thereof.

8. The method according to claim 1, wherein the potassium-bearing aluminosilicate composition and the sodium-bearing aluminosilicate composition comprise feldspathoid minerals selected from the group consisting of nepheline, kalsilite, sodalite, leucite, haüyne, cancrinite, and the like.

9. The method according to claim 1, wherein the potassium-bearing aluminosilicate composition and the sodium-bearing aluminosilicate composition comprise zeolite supergroup minerals comprising zeolites selected from the group consisting of analcime, chabazite, clinoptilolite, erionite, mordenite, phillipsite, ferrierite, natrolite, faujasite, and the like.

10. The method according to claim 1, wherein the potassium-bearing aluminosilicate composition and the sodium-bearing aluminosilicate composition comprise mica group and clay group minerals, wherein the mica and clay minerals are selected from the group consisting of muscovite, biotite, phlogopite, smectite, illite, vermiculite, saponite, lepidolite, hectorite, and the like.

11. The method according to claim 1, wherein the potassium base composition comprises is selected from the group consisting of potassium (K), potassium hydroxide (KOH), potassium carbonate (K₂CO₃), potassium oxide (K₂O), and mixtures thereof.

12. The method according to claim 1, wherein the sodium base composition comprises is selected from the group consisting of sodium (Na), sodium hydroxide (NaOH), sodium carbonate (Na₂CO₃), sodium oxide (Na₂O), and mixtures thereof.

13. The method according to claim 1, wherein the mixture of the potassium base composition and the sodium base composition comprises a mixture of two or more of compositions selected from the group consisting of potassium (K), potassium hydroxide (KOH), potassium carbonate (K₂CO₃), potassium oxide (K₂O), sodium (Na), sodium hydroxide (NaOH), sodium carbonate (Na₂CO₃), sodium oxide (Na₂O), and mixtures thereof.

14. The method according to claim 1, wherein the potassium aluminosilicate solid residue, sodium aluminosilicate solid residue, or mixture thereof produced from the treating step has a silicon/aluminum (Si:Al) ratio ranging from about 0.8-1.8.

15. The method according to claim 1, wherein the reacting step is conducted at a temperature ranging from about 150° C.-500° C., about 175° C.-225° C., or about 185° C.-210° C., at a pressure ranging from about 0-1500 pounds per square inch gauge (psig), about 50-600 psig, or about 100-300 psig for a period of time sufficient to leach substantially all remaining alkali into an alkali metal solution having a formula of M2CO₃, wherein M is a corresponding alkali metal.

16. The method according to claim 1, wherein the carbon dioxide produced from the method is substantially reused.

17. A composition comprising a potassium, sodium, or potassium and sodium leached aluminosilicate composition produced according to the method of claim 1.

18. A composition comprising a potassium, sodium, or potassium and sodium composition produced according to the method of claim 1.

19. A composition comprising an alkali product produced according to the method of claim 1, wherein the alkali product is selected from the group consisting of alkali carbonate, alkali silicate, and the like.

20. A method for extracting alkali from silicates, with concurrent formation of an activated synthetic kaolinite composition under carbon neutral conditions, said method comprising:
(a) providing a reaction mixture comprising an alkali-bearing aluminosilicate composition and an alkali base composition;
(b) treating the reaction mixture with a combined activation and leaching process to form a concentrated alkali-silicate solution and an alkali aluminosilicate solid residue, wherein carbon dioxide is produced as a carbon dioxide reusable co-product from the activation;
(c) reacting the alkali aluminosilicate solid residue with a first portion of the carbon dioxide reusable co-product to form an alkali leached aluminosilicate composition, thereby extracting alkali from the alkali-bearing aluminosilicate composition; and
(d) activating the alkali leached aluminosilicate composition to form an activated synthetic kaolinite composition.

21-26. (canceled)

27. The method according to claim 20, further comprising:
reacting the concentrated alkali-silicate solution with a second portion of the carbon dioxide reusable co-product to form a solid silica gel and an alkali-carbonate solution.

28. (canceled)

29. The method according to claim 27, wherein the solid silica gel is reused for reacting or combining with the alkali base composition to form alkali silicate or as activated silica source for inorganic polymer cement production, or wherein the solid silica gel is reused for reacting or combining with an alkali-silicate composition.

30. (canceled)

31. The method according to claim 27, further comprising:
isolating an alkali carbonate composition from the alkali-carbonate solution; and
combining the solid silica gel and the isolated alkali carbonate composition to form an alkali-silicate liquid.

32. (canceled)

33. The method according to claim 31, further comprising:
treating the alkali-silicate liquid to form an isolated alkali-silicate solid product.

34. A composition comprising an activated synthetic kaolinite composition produced according to the method of claim 20.

35. A composition comprising an alkali carbonate liquid produced according to the method of claim 20.

36. A composition comprising solid product produced according to the method of claim 20.

37. A composition comprising an alkali-silicate liquid produced according to the method of claim 31.

38. A composition comprising an alkali-silicate solid product produced according to the method of claim 33.

39. A method of preparing inorganic polymer cement, comprising:
providing an activated synthetic kaolinite composition produced according to the method of claim 20; and
using the activated synthetic kaolinite composition as a reagent to form inorganic polymer cement.

40. A composition comprising an inorganic polymer cement produced according to the method of claim 39.

41. A method of preparing inorganic polymer concrete, said method comprising:
providing an inorganic polymer cement according to claim 40; and
combining the inorganic polymer cement with a solid aggregate composition and an optional filler composition, thereby forming an inorganic polymer concrete,
wherein the inorganic polymer is present in an amount ranging from 1-44 weight percent (wt %), the solid aggregate composition is present in an amount ranging from 55-95 wt %, and the optional filler composition is present in an amount ranging from 1-20 wt % of the inorganic polymer concrete.

42. (canceled)

43. (canceled)

44. A composition comprising an inorganic polymer concrete produced according to the method of claim 41.

45. A method for extracting alkali from alkali-bearing silicates under carbon neutral conditions, said method comprising:
(a) providing a reaction mixture comprising an alkali-bearing aluminosilicate composition and an alkali base composition that comprises the alkali contained in the alkali-bearing aluminosilicate;
(b) treating the reaction mixture with a combined activation and leaching process to form a concentrated alkali-silicate solution and an alkali aluminosilicate solid residue, wherein carbon dioxide is produced as a carbon dioxide reusable co-product from the activation; and
(c) reacting the alkali aluminosilicate solid residue with a first portion of the carbon dioxide reusable co-product to form an alkali leached aluminosilicate composition, thereby extracting alkali from the alkali-bearing aluminosilicate composition.

46-63. (canceled)

64. A composition comprising an alkali leached aluminosilicate composition produced according to the method of claim 45.

65. The method according to claim 1, wherein the leached aluminosilicate composition is further activated to form an activated synthetic kaolinite composition comprising synthetic metakaolin, vitrified kaolinite, calcined synthetic kaolinite, flash calcined synthetic kaolinite, or activated synthetic kaolinite with a Si:Al ratio ranging from about 0.5-1.5, or combinations thereof.
